(19) United States
(12) Patent Application Publication
(10) Pub. No.: US 2024/0179769 A1
(43) Pub. Date: May 30, 2024

(54) NODE SELECTION METHOD, TERMINAL, AND NETWORK SIDE DEVICE

(71) Applicant: VIVO MOBILE COMMUNICATION CO., LTD., Dongguan (CN)

(72) Inventors: Tingting ZHONG, Dongguan (CN); Xiang PAN, Dongguan (CN)

(73) Assignee: VIVO MOBILE COMMUNICATION CO., LTD., Dongguan (CN)

(21) Appl. No.: 18/432,052

(22) Filed: Feb. 4, 2024

Related U.S. Application Data
(63) Continuation of application No. PCT/CN2022/111222, filed on Aug. 9, 2022.

(30) Foreign Application Priority Data
Aug. 13, 2021 (CN) 202110933005.X

(51) Int. Cl. H04W 76/14; H04W 92/18

(52) U.S. Cl. CPC H04W 76/14; H04W 92/18

(57) ABSTRACT

A node selection method, a terminal, and non-transitory readable storage medium are provided. The node selection method includes: a first node selecting a second node. The second node is used for performing positioning together with the first node. The first node is at least one of the following: a terminal, a base station, or a core network function. The second node is at least one of the following: a terminal, a base station, or a core network function. The second node comprises at least one of the following: a node that does not need to establish a connection to the first node, or a node that needs to establish a connection to the first node.

### CROSS-REFERENCE TO RELATED APPLICATIONS

This application is a continuation of International Application No. PCT/CN2022/111222, filed on Aug. 9, 2022, which claims priority to Chinese Patent Application No. 202110933005.X, filed on Aug. 13, 2021. The entire contents of each of the above-referenced applications are expressly incorporated herein by reference.

### TECHNICAL FIELD

This application relates to the field of communication technologies, and specifically, to a node selection method, a terminal, and a network side device.

### BACKGROUND

Currently, implementing positioning by sending and measuring a positioning reference signal based on a Sidelink (SL) between terminals is a new positioning method that is being discussed.

In the method of implementing positioning by sending and measuring a positioning reference signal based on a sidelink between terminals, when a node has a positioning demand, how to select another node to perform positioning is a problem.

### SUMMARY

Embodiments of this application provide a node selection method, a terminal, and a network side device.

According to a first aspect, a node selection method is provided. The method includes:

A first node selects a second node, where the second node is used for performing positioning together with the first node.

According to a second aspect, a node selection method is provided. The method includes:

A second node receives first information sent by a first node.

According to a third aspect, a node selection apparatus is provided. The apparatus includes:
a selection unit, configured to select a second node, where the second node is used for performing positioning together with a first node.

According to a fourth aspect, a node selection apparatus is provided. The apparatus includes:
a fourth receiving unit, configured to receive first information sent by a first node.

According to a fifth aspect, a terminal is provided. The terminal includes a processor, a memory, and a program or instructions stored in the memory and executable on the process, and when the program or instructions are executed by the processor, the steps of the node selection method according to the first aspect are implemented or the steps of the node selection method according to the second aspect are implemented.

According to a sixth aspect, a terminal is provided, including a processor and a communication interface, where the processor is configured to select a second node. The second node is used for performing positioning together with a first node. In some alternative embodiments, a terminal is provided, including a processor and a communication interface, where the communication interface is configured to receive first information sent by a first node.

According to a seventh aspect, a network side device is provided. The network side device includes a processor, a memory, and a program or instructions stored in the memory and executable on the process, and when the program or instructions are executed by the processor, the steps of the node selection method according to the first aspect are implemented or the steps of the node selection method according to the second aspect are implemented.

According to an eighth aspect, a network side device is provided, including a processor and a communication interface, where the processor is configured to select a second node. The second node is used for performing positioning together with a first node. In some alternative embodiments, a network side device is provided, including a processor and a communication interface, where the communication interface is configured to receive first information sent by a first node.

According to a ninth aspect, a readable storage medium is provided. The readable storage medium stores a program or instructions, and when the program or instructions are executed by a processor, the steps of the node selection method according to the first aspect is implemented or the steps of the node selection method according to the second aspect is implemented.

According to a tenth aspect, a chip is provided. The chip includes a processor and a communication interface, the communication interface is coupled to the processor, and the processor is configured to execute a program or instructions, to implement the node selection method according to the first aspect or implement the node selection method according to the second aspect.

According to an eleventh aspect, a computer program/program product is provided. The computer program/program product is stored in a non-transitory storage medium, and the program/program product is executed by at least one processor to implement the steps of the node selection method according to the first aspect or implement the steps of the node selection method according to the second aspect.

In the embodiments of this application, the first node selects the second node, where the second node is used for performing positioning together with the first node. This application may be applied to the method of implementing positioning by sending and measuring a positioning reference signal based on a sidelink between terminals, thereby implementing sidelink positioning.

### BRIEF DESCRIPTION OF THE DRAWINGS

FIG. 1 is a structural diagram of a wireless communication system according to an embodiment of this application;

FIG. 2 is a schematic architectural diagram of a Uu interface and a PC5 interface according to an embodiment of this application;

FIG. 3 is an overall flowchart of NR positioning according to an embodiment of this application;

FIG. 4 is a first schematic flowchart of a node selection method according to an embodiment of this application;

FIG. 5 is a second schematic flowchart of a node selection method according to an embodiment of this application;

FIG. 6 is a first schematic structural diagram of a node selection apparatus according to an embodiment of this application;

FIG. 7 is a second schematic structural diagram of a node selection apparatus according to an embodiment of this application;

FIG. 8 is a schematic structural diagram of a communication device according to an embodiment of this application;

FIG. 9 is a schematic diagram of a hardware structure of a terminal according to an embodiment of this application;

FIG. 10 is a first schematic structural diagram of a network side device according to an embodiment of this application; and

FIG. 11 is a second schematic structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some embodiments of this application rather than all of the embodiments. All other embodiments obtained by a person of ordinary skill in the art based on the embodiments of this application fall within the protection scope of this application.

In the specification and claims of this application, the terms “first” and “second” are used to distinguish between similar objects rather than describe a specific order or sequence. It should be understood that the terms used in this way is interchangeable in proper circumstances, so that the embodiments of this application can be implemented in orders other than the order illustrated or described herein. In addition, the objects distinguished by “first” and “second” generally belong to a same type, and a quantity of the objects is not limited. For example, there may be one first object or may be a plurality of first objects. In addition, in the specification and the claims, “and/or” indicates at least one of connected objects, and the character “/” generally indicates an “or” relationship between associated objects.

It should be noted that, the technology described in the embodiments of this application is not limited to a Long Term Evolution (LTE)/LTE-advanced (LTA-A) system, and may be further applied to other wireless communication systems, such as Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA) and other systems. The terms “system” and “network” in the embodiments of this application are usually used interchangeably, and the described technology may be applied to the systems and radio technologies mentioned above and may further be applied to other systems and radio technologies. The following describes a New Radio (NR) system for the purpose of exemplary description, and NR terms are used in most of the following description. However, the technology may also be applied to an application other than NR system applications, for example, a 6th Generation (6G) communication system.

FIG. 1 is a structural diagram of a wireless communication system according to an embodiment of this application. The wireless communication system includes terminals 11 and a network side device 12. The terminal 11 may also be referred to as a terminal device or a User Equipment (UE), and the terminal 11 may be a terminal side device such as a mobile phone, a tablet computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, a vehicle-mounted device, a pedestrian terminal, a smart home (household device having a wireless communication function, for example, a refrigerator, a television, a washing machine, or a furniture), and the like, where the wearable device includes: a smartwatch, a smart band, a smart headset, a smart glass, a smart jewelry (a smart bangle, a smart bracelet, a smart ring, a smart necklace, a smart anklet, or a smart ankle bracelet), a smart wristlet, a smart clothes, or a game console. It should be noted that, a specific type of the terminal 11 is not limited in the embodiments of this application. The network side device 12 may be a base station or a core network. The base station may be referred to as a NodeB, an evolved NodeB, an access point, a Base Transceiver Station (BTS), a radio base station, a radio transceiver, a Basic Service Set (BSS), an Extended Service Set (ESS), a NodeB, an evolved NodeB (eNB), a home NodeB, a home evolved NodeB, a WLAN access point, a Wi-Fi node, a Transmission Reception Point (TRP), or another suitable term in the field, and provided that a same technical effect can be achieved, the base station is not limited to a specific technical term. It should be noted that, a base station in an NR system is merely used as an example in the embodiments of this application, and a specific type of the base station is not limited.

With the development of communication technologies and the richness of demands, application scenarios of wireless communication are increasingly wide, and a typical application scenario is the Internet of vehicles. V2X means vehicle-to-everything and is intended to implement information exchange between a vehicle and every entity implementation that may affect the vehicle, and objectives thereof are to reduce accident occurrence, alleviate traffic congestion, reduce environmental pollution, and provide other information services. According to different types of a peer communication node of the vehicle, V2X mainly include Vehicle-to-Vehicle (V2V), Vehicle-to-Infrastructure (V2I), Vehicle-to-Network (V2N), and Vehicle-to-Pedestrian (V2P).

To be different from an uplink link and a downlink link based on a Uu interface between a conventional UE) terminal and a base station, a communication link between a vehicle terminal and another node (other than the base station) is referred to as an SL. A Sidelink link interface may also be referred to as a PC5 interface.

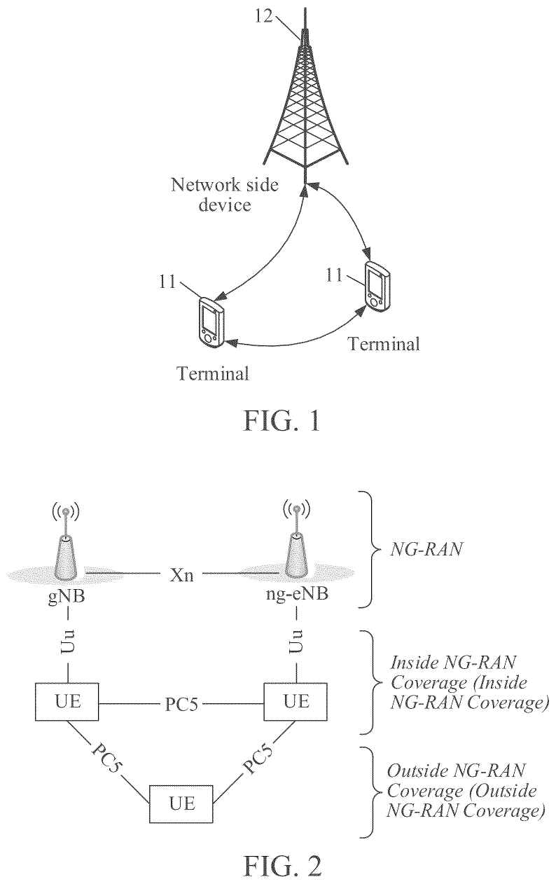

FIG. 2 is a schematic architectural diagram of a Uu interface and a PC5 interface. PC5 interface-based Sidelink transmission is independent of an RRC state and a cellular network coverage state of a UE, that is, the UE may perform sidelink communication in a case without cellular network coverage.

NR supports three Sidelink communication modes: Unicast, Groupcast, and Broadcast. For the unicast mode, a Sidelink unicast link is established, modified, and released between UEs by exchanging PC5-S and PC5-RRC messages.

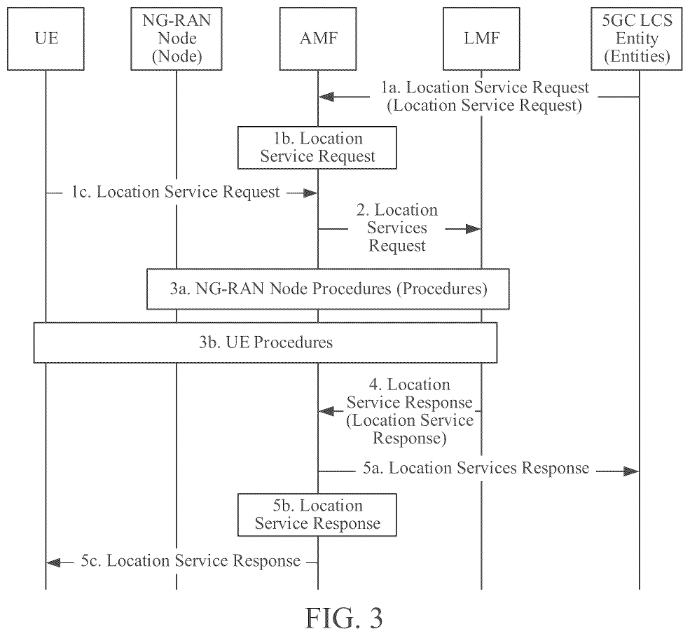

FIG. 3 is an overall flowchart of NR positioning. Functions of key nodes in FIG. 3 are shown in Table 1.

TABLE 1
Functions of key nodes

| Node | Function |
|---|---|
| UE | Perform reference signal measurement on a Next Generation |
| | Radio Access Network (NG-RAN) node |
| | Report a measurement result |
| | Calculate a positioning result |
| NG-RAN | Provide assistance information, for example, latitudes |
| Node | and longitudes of a base station and a Positioning |
| | Reference Signal (PRS) configuration, to a Location |
| | Management Function (LMF) |
| | Broadcast the assistance information |
| | Perform reference signal measurement on the UE |
| | Report a measurement result |
| LMF | Manage the assistance information |
| | Select a positioning manner |
| | Provide a key to encrypt and broadcast a Positioning System |
| | Information Block (PosSIB) |
| | Obtain a measurement result |
| | Calculate a positioning result |

The NR positioning supports UE-based and UE-assisted positioning, and is enhanced based on an LTE positioning method, that is, introduces a new positioning method.

Current positioning technologies include a Radio Access Technology dependent (RAT-dependent) method (implementing positioning by sending and measuring a positioning reference signal by using a Uu interface between a terminal and a base station) or a RAT-independent method (for example, Global Navigation Satellite System (GNSS) positioning), and implementing positioning by sending and measuring a positioning reference signal based on a sidelink between terminals is a new positioning method that is being discussed.

The embodiments of this application provide the following node selection method. The node selection method provided in the embodiments of this application are described in detail through some embodiments and application scenarios thereof with reference to the accompanying drawings.

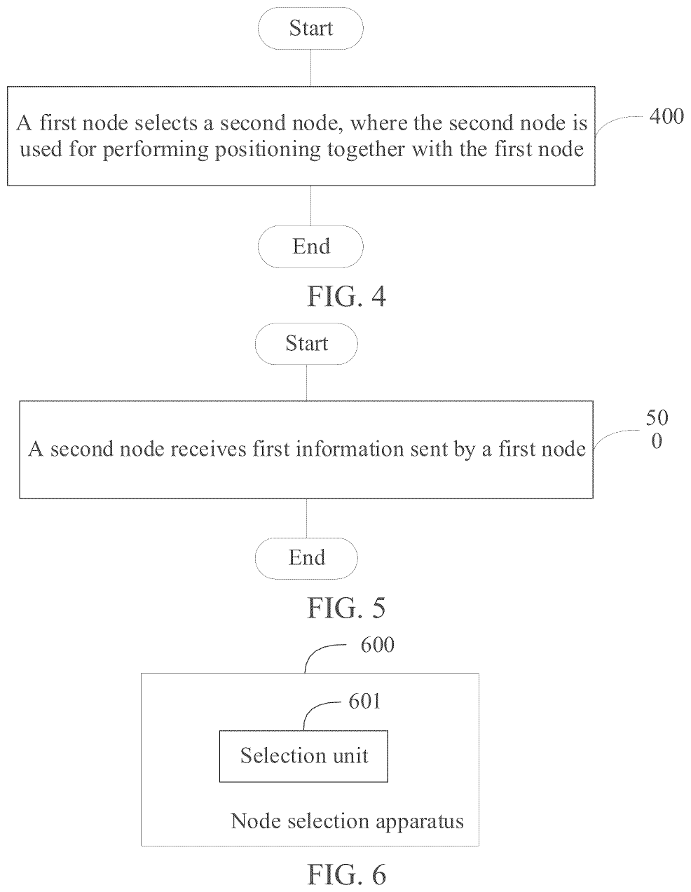

FIG. 4 is a first schematic flowchart of a node selection method according to an embodiment of this application. As shown in FIG. 4, an execution entity of the method is a first node, and the method includes the following steps:

Step 400. The first node selects a second node. The second node is used for performing positioning together with the first node.

The first node is a node having a positioning demand.

The second node being used for performing positioning together with the first node may be understood as that, the second node is configured to perform an operation related to performing positioning together with the first node. For example, the second node sends, measures, and/or processes a positioning reference signal, to position the first node.

In some embodiments, the first node selects at least one second node.

In some embodiments, a quantity of the second nodes is limited or unlimited.

In the embodiments of this application, the first node selects the second node, where the second node is used for performing positioning together with the first node. This application may be applied to the method of implementing positioning by sending and measuring a positioning reference signal based on a sidelink between terminals, thereby implementing sidelink positioning.

The first node includes at least one of the following:
a terminal;
a base station; or
a core network function.

The second node includes at least one of the following:
a terminal;
a base station; or
a core network function.

The terminal may be a vehicle, a Vulnerable Road Users (VRU), a Road Side Unit (RSU), a pedestrian, or the like.

The core network function may be an Access and Mobility Management Function (AMF), an LMF, a Session Management Function (SMF), or the like.

In some embodiments, in a case that the first node is a terminal, the second node is a terminal, a base station, or a core network function; and in a case that the first node is a base station or a core network function, the second node is a terminal.

In some embodiments, the second node includes at least one of the following:
a node that does not need to establish a connection to the first node; or
a node that needs to establish a connection to the first node.

In some embodiments, when the first node selects the second node, no connection needs to be established between the first node and the second node, that is, the first node selects the second node before a connection is established between the first node and the second node.

In some embodiments, after the first node selects the second node, the first node establishes a connection to the selected second node.

In some embodiments, when the first node selects the second node, the second node needs to establish a connection to the first node.

Further, in a case that the second node is a node that needs to establish a connection to the first node, the step that the first node selects the second node is performed in a process of establishing a connection between the first node and the second node, and/or after the process of establishing a connection between the first node and the second node.

In some embodiments, the first node selects the second node in a process of establishing a connection to the second node.

In some embodiments, the first node selects the second node after a connection is established between the first node and the second node.

In some embodiments, the second node is selected in the process of establishing a connection between the first node and the second node and after a connection is established between the first node and the second node. For example, the first node is a UE A, the second node includes a UE B and a UE C, the UE A selects the UE B in a process of establishing a connection to the UE B, and the UE A selects the UE C after establishing a connection to the UE C.

In some embodiments, the establishing a connection between the first node and the second node includes one of the following:
in a case that one of the first node and the second node is a terminal and the other is a base station, establishing a Radio Resource Control (RRC) connection between the first node and the second node;
in a case that both the first node and the second node are terminals, establishing a PC5 unicast link connection between the first node and the second node; and/or in a case that both the first node and the second node are terminals, establishing a PC5-RRC connection between the first node and the second node; or
in a case that one of the first node and the second node is a terminal and the other is a core network function, establishing a Non Access Stratum (NAS) connection between the first node and the second node.

It may be understood that, in a case that one of the first node and the second node is a terminal and the other is a base station, the connection established between the first node and the second node is an RRC connection. For example, an RRC connection is established between a UE and a base station, and the UE is in an RRC connected CONNECTED state.

In some embodiments, in a case that both the first node and the second node are terminals, the connection established between the first node and the second node is a PC5 unicast link connection PC5 unicast link. For example, PC5 unicast link establishment is completed between a UE A and a UE B, and transmission of control information and user data is performed through a sidelink between the UE A and the UE B.

In some embodiments, in a case that both the first node and the second node are terminals, the connection established between the first node and the second node is a PC5-RRC connection. For example, an RRC connection is established between a UE A and a UE B through a PC5 interface.

In some embodiments, in a case that both the first node and the second node are terminals, the connection established between the first node and the second node is a PC5 unicast link and PC5-RRC. For example, the first node is a UE A, the second node is a UE B, and both PC5 unicast link establishment and a PC5 interface RRC connection are completed between the UE A and the UE B.

In some embodiments, in a case that one of the first node and the second node is a terminal and the other is a core network function, the connection established between the first node and the second node is a NAS connection. For example, a connection is established between a UE and an AMF through an N1 interface.

In some embodiments, the establishing a PC5 unicast link connection between the first node and the second node includes least one of the following:
sending, by the first node, a request message for establishing a PC5 unicast link to the second node in a PC5 broadcast manner; or
sending, by the first node, a request message for establishing a PC5 unicast link to the second node in a PC5 unicast manner.

In some optional embodiments, in a case that the step that the first node selects the second node is performed in the process of establishing a connection between the first node and the second node, first information is carried in the request message for establishing a PC5 unicast link.

It should be noted that, the first information is used for assisting the first node in selecting the second node. For example, the first node includes a first requirement (that is, a requirement on the second node) in the first information, and information can be fed back to the first node only when the second node meets the first requirement, so that the second node is filtered.

In another example, the first information includes positioning-related information, a second node that is interested in the positioning-related information sends feedback information to the first node, and the first node then selects the second node according to the feedback information.

Further, the first information includes a requirement on the second node and/or positioning-related information. For example, in a process that a UE having a positioning demand establishes a PC5 unicast link, the positioning requirement and/or positioning-related information are/is placed in a request message for establishing the PC5 unicast link.

After obtaining the first information sent by the first node, if the second node determines that the second node meets a positioning requirement in the first information or that the second node is interested in the positioning-related information in the first information, the second node may respond to the first node. The first node receives response information of the second node, determines that the second node has a positioning capability, and selects the second node to perform positioning. If the second node does not meet the requirement in the first information or is not interested in the positioning-related information in the first information, the second node does not respond to the request message for establishing a PC5 unicast link sent by the first node. The first node does not receive response information of the second node and further does not select the second node to perform positioning.

In the embodiments of this application, the first node selects the second node in the process of establishing a PC5 unicast link connection between the first node and the second node, the first node sends the first information to the second node, so that the first node selects the second node according to feedback of the second node, where the first information is carried in the request message for establishing a PC5 unicast link, so that a node used for performing positioning may be selected.

In some embodiments, content of the request message for establishing a PC5 unicast link includes:
the first information;
an application layer identifier Application Layer ID of the first node; or
a default destination Layer-2 ID in a case that the request message for establishing a PC5 unicast link is broadcast through a PC5.

In some embodiments, the Application Layer ID of the first node includes but is not limited to at least one of the following: an application whose Application Layer ID is associated with positioning, an application whose Application Layer ID is associated with relative positioning, an application whose Application Layer ID is associated with absolute positioning, an application whose Application Layer ID is associated with relative positioning and an application whose Application Layer ID is associated with absolute positioning, an application whose Application Layer ID is associated with a positioning category 1 (for example, high-precision positioning), an application whose Application Layer ID is associated with a positioning category 1 (for example, medium-precision positioning), or an application whose Application Layer ID is associated with a relative positioning category 1 (for example, high-precision relative positioning).

In some embodiments, the default destination Layer-2 ID includes but is not limited to at least one of the following: an application whose default destination Layer-2 ID is associated with positioning, an application whose default destination Layer-2 ID is associated with relative positioning, an application whose default destination Layer-2 ID is associated with absolute positioning, an application whose default destination Layer-2 ID is associated with relative positioning and an application whose default destination Layer-2 ID is associated with absolute positioning, an application whose default destination Layer-2 ID is associated with a positioning category 1 (for example, high-precision positioning), an application whose default destination Layer-2 ID is associated with a positioning category 1 (for example, medium-precision positioning), or an application whose default destination Layer-2 ID is associated with a relative positioning category 1 (for example, high-precision relative positioning).

In some embodiments, content of the first information includes at least one of the following:
a first requirement;
positioning-related information;
information about the first node; or
requesting for information about the second node.

The first requirement is a requirement on the second node, and the second node responds to the request message for establishing a PC5 unicast link sent by the first node only in a case that the second node meets the first requirement.

In the embodiments of this application, the first information includes a requirement on the second node and/or positioning-related information, and a node used for performing sidelink positioning may be selected through exchange of the positioning-related information.

In some embodiments, the first requirement includes at least one of the following:
a capability requirement on the second node;
a Reference Signal Receiving Power (RSRP) threshold value;
a requirement on zone Zone information of the second node;
a movement state requirement on the second node;
a network coverage state requirement on the second node; or
a PC5 unicast link state requirement on the second node.

For example, the second node responds to the request message for establishing a PC5 unicast link sent by the first node only when RSRP of the second node is higher than the RSRP threshold value.

The Zone information includes a Zone ID, a Zone ID list, or the like.

The capability requirement on the second node includes at least one of the following:
having an absolute positioning capability;
having a relative positioning capability;
having a radio access technology-dependent RAT-dependent positioning capability;
having a radio access technology-independent RAT-independent positioning capability;
having a capability of performing positioning through a sidelink;
positioning precision; or
a capability having positioning integrity.

The second node having an RAT-dependent positioning capability refers to that the second node supports an RAT-dependent positioning method, for example, implementing positioning by sending and measuring a positioning reference signal through a Uu interface between a terminal and a base station.

The second node having a radio access technology-independent RAT-independent positioning capability refers to that the second node supports an RAT-independent positioning method, for example, a GNSS positioning method.

The positioning precision includes: high precision, medium precision, low precision, a precision interval, being not lower than X, being not higher than Y, or the like. Value ranges of “high”, “medium”, and “low” may be pre-agreed.

The capability having positioning integrity refers to positioning integrity.

In some embodiments, the movement state requirement on the second node includes at least one of the following:
being in a static state;
being in a moving state;
a static state is prior to a moving state;
a movement speed is not higher than a first threshold;
a movement speed is a value in a set;
a movement speed is not lower than a second threshold; or
a level of a movement speed.

For example, the level of the movement speed includes high, medium, and low. Value ranges of “high”, “medium”, and “low” may be pre-agreed.

In some embodiments, the network coverage state requirement on the second node includes at least one of the following:
the second node needs to be located in coverage of a base station; or
the second node does not need to be located in coverage of a base station.

In some embodiments, the PC5 unicast link state requirement on the second node includes at least one of the following:
needing to have established a PC5 unicast link to other terminals other than the first node;
not needing to have established a PC5 unicast link to other terminals other than the first node;
a quantity of other terminals to which a PC5 unicast link has been established is not lower than a third threshold;
a quantity of other terminals to which a PC5 unicast link has been established is not higher than a fourth threshold; or
a set/interval of a quantity of other terminals to which a PC5 unicast link has been established.

In some embodiments, the positioning-related information includes at least one of the following:
positioning precision/accuracy;
positioning integrity;
a positioning type;
a positioning update cycle; or
a positioning technology.

That is, the first information including positioning-related information refers to that the first information includes at least one of the following: precision/accuracy required for this positioning, integrity required for this positioning, a type (for example, absolute positioning or relative positioning) required for this positioning, an update cycle of this positioning, a technology used in this positioning (for example, time-based positioning, angle-based positioning, or RSRP-based distance positioning).

In some embodiments, the information about the first node or the information about the second node includes at least one of the following:
Zone information of the first node or the second node;
movement state information;
a network coverage state;
a PC5 unicast link state; or
positioning-related capability information.

It may be understood that, the information about the first node includes at least one of the following: the Zone information of the first node; movement state information of the first node; a network coverage state of the first node; a PC5 unicast link state of the first node; or positioning-related capability information of the first node.

The information about the second node includes at least one of the following: the Zone information of the second node; movement state information of the second node; a network coverage state of the second node; a PC5 unicast link state of the second node; or positioning-related capability information of the second node.

In some embodiments, the movement state information includes at least one of the following:
a static state or a moving state;
a movement speed value;
a level of a movement speed;
a movement speed is not lower than a fifth threshold and/or not higher than a sixth threshold; or
an interval of a movement speed value.

In some embodiments, the network coverage state includes at least one of the following:
being located in a coverage range of a base station; or
not being located in a coverage range of a base station.

In some embodiments, the PC5 unicast link state includes at least one of the following:
having established a PC5 unicast link to other terminals or having not established a PC5 unicast link to other terminals;
in a case of being a PC5 unicast link state of the second node, having established a PC5 unicast link to other terminals other than the first node or having not established a PC5 unicast link to other terminals other than the first node;
a quantity of other terminals to which a PC5 unicast link has been established is not lower than a seventh threshold;
in a case of being a PC5 unicast link state of the second node, a quantity of other terminals other than the first node to which a PC5 unicast link has been established is not lower than an eighth threshold;
a quantity of other terminals to which a PC5 unicast link has been established is not higher than a ninth threshold;
in a case of being a PC5 unicast link state of the second node, a quantity of other terminals other than the first node to which a PC5 unicast link has been established is not higher than a tenth threshold;
a set of a quantity of other terminals to which a PC5 unicast link has been established; or
in a case of being a PC5 unicast link state of the second node, a set of a quantity of other terminals other than the first node to which a PC5 unicast link has been established.

The set refers to giving a plurality of values rather than giving a specific value, or an interval in which a value is located.

In some embodiments, the positioning-related capability information includes at least one of the following:
having an absolute positioning capability;
having a relative positioning capability;
having an RAT-dependent positioning capability;
having an RAT-independent positioning capability;
having a capability of performing positioning through a sidelink;
positioning precision; or
a capability having positioning integrity.

In some embodiments, after the step of sending the request message for establishing a PC5 unicast link to the second node, the method further includes:
receiving, by the first node, second information sent by the second node.

In the embodiments of this application, the first node receives the second information fed back by the second node and determines whether to select the second node, so that a node used for performing sidelink positioning may be selected.

In some embodiments, the receiving, by the first node, second information sent by the second node includes:
receiving, by the first node, the second information sent by the second node in a case that a first condition is met.

In some embodiments, the first condition includes at least one of the following:
in a case that the first information includes a first requirement, the second node meets the first requirement in the first information; or
in a case that the first information includes positioning-related information, the second node is interested in the positioning-related information in the first information.

It may be understood that, the first node receiving the second information sent by the second node indicates that after the first information sent by the first node is obtained, the second node determines that the second node meets the positioning requirement in the first information and/or that the second node is interested in the positioning-related information in the first information. Further, the first node determines that the second node has a positioning capability and selects the second node to perform positioning.

If the second node does not meet the requirement in the first information or is not interested in the positioning-related information in the first information, the second node does not respond to the request message for establishing a PC5 unicast link sent by the first node, and the second node does not send the second information to the first node. If the first node does not receive the second information sent by the second node, the first node does not select the second node to perform positioning.

In some embodiments, content of the second information includes at least one of the following:
Zone information of the second node;
an RSRP value measured by the second node;
movement state information of the second node;
a network coverage state of the second node;
a PC5 unicast link state of the second node; or
positioning-related capability information of the second node.

It should be noted that, for understanding of the content of the second information, reference may be made to the description of the Zone information, the movement state information, the network coverage state, the PC5 unicast link state, and the positioning-related capability information in the foregoing embodiments, and details are not described herein again.

In the embodiments of this application, the second information includes Zone information, movement state information, a network coverage state, a PC5 unicast link state, and positioning-related capability information, and a node used for performing sidelink positioning may be selected through exchange of the second information.

In some embodiments, the second information is sent through a message, a Media Access Control Control Element (MAC CE) and/or Sidelink Control Information (SCI).

In some embodiments, the request message for establishing a PC5 unicast link includes at least one of the following:
a direct communication request Direct Communication Request message;
a newly defined request message for establishing a PC5 unicast link; or
a message related to establishment security of the second node.

In some embodiments, the second information may be carried in different messages, and for example, at least one of the following may be included:
in a case that the request message for establishing a PC5 unicast link is a Direct Communication Request message, the second information is carried in a direct communication accept Direct Communication Accept message;
in a case that the request message for establishing a PC5 unicast link is a newly defined request message for establishing a PC5 unicast link, the second information is carried in a newly defined request message for responding to establishment of the PC5 unicast link, where
the newly defined request message carrying the second information for responding to establishment of the PC5 unicast link is a newly defined new message different from the previous Direct Communication Accept message to establish a PC5 unicast link between two terminals for a positioning-related function; or
in a case that the request message for establishing a PC5 unicast link is a message related to establishment security of the second node, the second information is carried in a message related to establishment security of the first node.

In some embodiments, the message related to establishment security of the first node is a message in a Direct Auth and Key Establishment procedure and/or a Direct Security Mode Command procedure.

In the embodiments of this application, various manners for performing information exchange between the first node and the second node are provided, so that the flexibility of selecting a node used for performing sidelink positioning may be improved.

In some other embodiments, in a case that the step that the first node selects the second node is performed after the process of establishing a connection between the first node and the second node, the method further includes:
sending, by the first node, first information to the second node.

That is, the first node sends the first information to the second node after a connection is established between the first node and the second node.

To reduce resource overheads, the content of the first information is not carried in the request message for establishing a PC5 unicast link sent by the first node to the second node.

In the embodiments of this application, after a connection is established between the first node and the second node, the first node sends the first information to the second node. The first information is information sent by the first node to the second node to cause the first node to select the second node according to feedback of the second node, so that a node used for performing sidelink positioning may be selected.

In some embodiments, content of the first information includes at least one of the following:
a first requirement;
positioning-related information;
information about the first node; or
requesting for information about the second node.

It should be noted that, for the content of the first information, reference may be made to the description in the foregoing embodiments, and details are not described herein again.

In some embodiments, the first information is sent through a message, a MAC CE, and/or SCI.

In some embodiments, after the sending, by the first node, first information to the second node, the method further includes at least one of the following:
receiving, by the first node, second information sent by the second node.

For example, the node selection method provided in this embodiment includes the following steps:
sending, by the first node, first information to the second node after a connection is established between the first node and the second node;
receiving, by the first node, second information sent by the second node; and
selecting, by the first node, the second node.

In some embodiments, the receiving, by the first node, second information sent by the second node includes:
receiving, by the first node, the second information sent by the second node in a case that a first condition is met.

For example, the node selection method provided in this embodiment includes the following steps:
sending, by the first node, first information to the second node after a connection is established between the first node and the second node;
receiving, by the first node, second information sent by the second node in a case that a first condition is met; and
selecting, by the first node, the second node.

In the embodiments of this application, a node used for performing sidelink positioning may be selected through exchange of the second information.

In some embodiments, the first condition includes at least one of the following:
in a case that the first information includes a first requirement, the second node meets the first requirement in the first information; or
in a case that the first information includes positioning-related information, the second node is interested in the positioning-related information in the first information.

In some embodiments, content of the second information includes at least one of the following:
Zone information of the second node;
an RSRP value measured by the second node;
movement state information of the second node;
a network coverage state of the second node;
a PC5 unicast link state of the second node; or
positioning-related capability information of the second node.

For understanding of the content of the second information in this embodiment, reference may be made to the description in the foregoing embodiments, and details are not described herein again.

In some embodiments, the second information is sent through a message, a MAC CE, and/or SCI.

In some embodiments, the first node sends the first information to the second node through at least one of the following:
a UECapabilityEnquirySidelink message;
an RRCReconfigurationSidelink message;
a Link Identifier Update Request message;
a Link Identifier Update Ack message;
a Disconnect Request message;
a Link Modification Request message;
a Keep-alive message;
a newly defined PC5-RRC message; or
a newly defined PC5-S message.

In some embodiments, the second information may be carried in different messages, and for example, at least one of the following may be included:
in a case that the first node sends the first information to the second node through the UECapabilityEnquirySidelink message, the second information is carried in a UECapabilityInformationSidelink message;
in a case that the first node sends the first information to the second node through the RRCReconfigurationSidelink message, the second information is carried in an RRCReconfigurationCompleteSidelink message;
in a case that the first node sends the first information to the second node through the Link Identifier Update Request message, the second information is carried in a Link Identifier Update Response message;
in a case that the first node sends the first information to the second node through the Disconnect Request message, the second information is carried in a Disconnect Response message;
in a case that the first node sends the first information to the second node through the Link Modification Request message, the second information is carried in a Link Modification Accept message;
in a case that the first node sends the first information to the second node through the Keep-alive message, the second information is carried in a Keep-alive Ack message;
in a case that the first node sends the first information to the second node through the newly defined PC5-RRC message, the second information is carried in the newly defined PC5-RRC message; or
in a case that the first node sends the first information to the second node through the newly defined PC5-S message, the second information is carried in the newly defined PC5-S message.

In the embodiments of this application, various manners for performing information exchange between the first node and the second node are provided, so that the flexibility of selecting a node used for performing sidelink positioning is improved.

In some embodiments, in a case that the step that the first node selects the second node is performed in the process of establishing a connection between the first node and the second node, or in a case that the second node does not need to establish a connection to the first node, the method further includes:
broadcasting, by the first node, first information to the second node.

In some embodiments, the first node broadcasts the first information to the second node in the process of establishing a connection between the first node and the second node.

In some embodiments, the first node selects the second node according to feedback of the second node to the first information.

In this case, to reduce resource overheads, content of the first information is not carried in the request message for establishing a PC5 unicast link sent by the first node to the second node.

In some embodiments, in a case that the second node does not need to establish a connection to the first node, the node selection method includes the following steps: broadcasting, by the first node, first information to the second node; selecting, by the first node, the second node according to feedback of the second node to the first information; and establishing, by the first node, a connection to the selected second node.

In the embodiments of this application, the first node broadcasts the first information to the second node. The first information is information sent by the first node to the second node to cause the first node to select the second node used for performing positioning according to feedback of the second node, so that a node used for performing sidelink positioning may be selected.

In some embodiments, content of the first information includes at least one of the following:
a first requirement;
positioning-related information;
information about the first node; or
requesting for information about the second node.

It should be noted that, for the content of the first information, reference may be made to the description in the foregoing embodiments, and details are not described herein again.

In some embodiments, after the step of broadcasting, by the first node, first information to the second node, the method further includes at least one of the following:
receiving, by the first node, second information sent by the second node.

For example, the node selection method provided in this embodiment includes the following steps:
broadcasting, by the first node, first information to the second node in the process of establishing a connection between the first node and the second node or before a connection is established between the first node and the second node;
receiving, by the first node, second information sent by the second node; and
selecting, by the first node, the second node.

In some embodiments, the receiving, by the first node, second information sent by the second node includes:
receiving, by the first node, the second information sent by the second node in a case that a first condition is met.

For example, the node selection method provided in this embodiment includes the following steps:
broadcasting, by the first node, first information to the second node in the process of establishing a connection between the first node and the second node or before a connection is established between the first node and the second node;
receiving, by the first node, second information sent by the second node in a case that a first condition is met; and
selecting, by the first node, the second node.

In some embodiments, the first condition includes at least one of the following:
in a case that the first information includes a first requirement, the second node meets the first requirement in the first information; or
in a case that the first information includes positioning-related information, the second node is interested in the positioning-related information in the first information.

In some embodiments, content of the second information includes at least one of the following:
an Application Layer ID of the first node;
a default destination Layer-2 ID in a case that the second information is broadcast through a PC5;
Zone information of the second node;
an RSRP value measured by the second node;
movement state information of the second node;
a network coverage state of the second node;
a PC5 unicast link state of the second node; or
positioning-related capability information of the second node.

For understanding of the content of the second information in this embodiment, reference may be made to the description in the foregoing embodiments, and details are not described herein again.

In the embodiments of this application, the first node receives the second information sent by the second node after broadcasting the first information to the second node, and a node used for performing sidelink positioning may be selected through information exchange between the first node and the second node.

In some embodiments, the second information may be carried in different messages, and for example, at least one of the following may be included:
in a case that the step that the first node selects the second node is performed in the process of establishing a connection between the first node and the second node, the second information is carried in a Direct Communication Request message;
in a case that the step that the first node selects the second node is performed in the process of establishing a connection between the first node and the second node, the second information is carried in a newly defined request message for establishing a PC5 unicast link;
in a case that the step that the first node selects the second node is performed in the process of establishing a connection between the first node and the second node, the second information is carried in a message related to establishment security of the first node; or
in a case that the second node does not need to establish a connection to the first node, the second information is carried in a broadcast message other than a request message for establishing a PC5 unicast link.

In the embodiments of this application, various manners for performing information exchange between the first node and the second node are provided, so that the flexibility of selecting a node used for performing sidelink positioning is improved.

Based on the foregoing embodiments, for example, the selecting, by a first node, a second node includes:
selecting, by the first node, the second node according to a first rule, where
the first rule is agreed on in a protocol and/or depends on an implementation of the first node.

As described in the foregoing embodiments, the first node selects the second node according to the feedback of the second node to the first information, and a specific manner in which the first node selects the second node according to the feedback of the second node to the first information may be agreed on in a protocol and/or depend on an implementation of the first node. For example, in a process of establishing a PC5 unicast link by a UE having a positioning demand, the UE may place positioning-related information and a positioning requirement in a corresponding message (for example, a Direct Communication Request message), another UE meeting the positioning requirement responds to the message of the UE, and the UE selects the another UE responding to the message of the UE to perform positioning. In some alternative embodiments, a UE having a positioning demand broadcasts positioning-related information and a requirement, selects a UE used for performing positioning according to feedback of another UE, and may then establish a PC5 unicast link to the selected UE. In some alternative embodiments, after a UE having a positioning demand establishes a PC5 unicast link to another UE, positioning capabilities are exchanged, and a UE used for performing positioning is selected according to feedback of the another UE.

In the embodiments of this application, the first node selects the second node according to the first rule, so that an effect of selecting a node used for performing sidelink positioning may be ensured.

In some embodiments, after the step that the first node selects the second node, the method further includes:
sending, by the first node, third information to the second node.

That is, after selecting the second node, the first node notifies the second node through the third information that whether the second node is selected.

In some embodiments, in a case that all second nodes are selected, the first node sends the third information to all the second nodes.

In some embodiments, in a case that some second nodes are selected, the first node sends the third information to the selected second nodes.

In some embodiments, in a case that some second nodes are selected, the first node sends the third information to unselected second nodes.

In some embodiments, the sending, by the first node, third information to the second node includes at least one of the following:
sending, by the first node, the third information to a selected second node; or
sending, by the first node, the third information to an unselected second node.

In some embodiments, the third information includes at least one of the following:
in a case that the first node sends the third information to a selected second node, information used for indicating that the second node is selected by the first node as a node used for performing positioning;
in a case that the first node sends the third information to an unselected second node, information used for indicating that the second node is not selected by the first node as a node used for performing positioning;
information used for indicating that the second node is not selected by the first node as a node used for performing positioning; or
information used for indicating that the second node is selected by the first node as a node used for performing positioning.

In the embodiments of this application, after selecting the second node, the first node sends notification information to a corresponding node, so that an effect of selecting a node used for performing sidelink positioning may be ensured.

In some embodiments, the selecting, by a first node, a second node includes:
selecting, by the first node, the second node according to first indication information sent by a third node.

The first indication information is used for indicating a second node that may be used for performing positioning to the first node.

In some embodiments, when the first node selects the second node without a connection established between the first node and the second node and both the first node and the second node are terminals, the first node selects the second node according to indication information of the third node.

In some embodiments, the third node is at least one of the following: a base station; or a core network function.

In some embodiments, after the selecting, by the first node, the second node according to first indication information sent by a third node, the method further includes: sending, by the first node, a Direct Communication Request message to the second node.

In the embodiments of this application, the terminal may directly select the second node according to indication of the base station and/or the core network function, so that a node used for performing sidelink positioning may be selected conveniently.

Based on the foregoing embodiments, a quantity of the second nodes meets any one of the following:
unlimited; or
limited.

Unlimited means that there is no requirement on the quantity of the second nodes. Limited means that there is a certain requirement on the quantity of the second nodes.

In the embodiments of this application, the first node may send the first information to a limited quantity of second nodes, and select at least one second node to implement sidelink positioning.

FIG. 5 is a second schematic flowchart of a node selection method according to an embodiment of this application. As shown in FIG. 5, an execution entity of the method is a second node, and the method includes the following steps:

Step 500. The second node receives first information sent by a first node.

For understanding of the first node and the second node, reference may be made to the description in the embodiment shown in FIG. 4, and details are not described herein again.

It should be noted that, the first information is used for assisting the first node in selecting the second node. For example, the first node includes a first requirement (that is, a requirement on the second node) in the first information, and information can be fed back to the first node only when the second node meets the first requirement, so that the second node is filtered.

In another example, the first information includes positioning-related information, a second node that is interested in the positioning-related information sends feedback information to the first node, and the first node then selects the second node according to the feedback information.

Further, the first information includes a requirement on the second node and/or positioning-related information.

In some embodiments, content of the first information includes at least one of the following:
a first requirement;
positioning-related information;
information about the first node; or
requesting for information about the second node.

It should be noted that, for understanding of the content of the first information, reference may be made to the description in the embodiment shown in FIG. 4, and details are not described herein again.

In the embodiments of this application, the second node receives the first information sent by the first node, where the second node is used for performing positioning together with the first node. This application may be applied to the method of implementing positioning by sending and measuring a positioning reference signal based on a sidelink between terminals, thereby implementing sidelink positioning.

In some embodiments, that the second node receives the first information sent by the first node includes:
receiving a request message for establishing a connection sent by the first node; and
obtaining the first information carried in the request message for establishing a connection.

That is, the first information is carried in the request message for establishing a connection, and the first node selects the second node in a process of establishing a connection between the first node and the second node.

In some embodiments, the request message for establishing a connection is a request message for establishing a PC5 unicast link.

In some embodiments, before the step that the second node receives the first information sent by the first node, the method further includes:
establishing, by the second node, a connection to the first node.

That is, the step that the first node selects the second node is performed after a connection is established between the first node and the second node.

In some embodiments, that the second node receives the first information sent by the first node includes:
in a case that the second node does not establish a connection to the first node, receiving, by the second node, the first information broadcast by the first node; or
in a case that the step that the first node selects the second node is performed in a process of establishing a connection between the first node and the second node, receiving, by the second node, the first information broadcast by the first node.

That is, if the first node selects the second node without a connection established between the first node and the second node or the first node selects the second node in the process of establishing a connection between the first node and the second node, the first information may be sent by the first node in a broadcast manner.

In some embodiments, the method further comprises:
sending, by the second node, second information to the first node.

In the embodiments of this application, the second node feeds back the second information to the first node, so that the first node may determine whether to select the second node, and a node used for performing sidelink positioning may be selected.

In some embodiments, the sending, by the second node, second information to the first node includes:
sending, by the second node, the second information to the first node in a case that a first condition is met.

In some embodiments, the first condition includes at least one of the following:
in a case that the first information includes a first requirement, the second node meets the first requirement in the first information; or
in a case that the first information includes positioning-related information, the second node is interested in the positioning-related information in the first information.

In some embodiments, after obtaining the first information sent by the first node, if the second node determines that the second node meets a positioning requirement in the first information and/or that the second node is interested in the positioning-related information in the first information, the second node sends the second information to the first node, so that the first node determines that the second node has a positioning capability and selects the second node for performing positioning.

It may be understood that, if the second node does not meet the requirement in the first information or is not interested in the positioning-related information in the first information, the second node does not respond to the first information sent by the first node, and the second node does not send the second information to the first node. If the first node does not receive the second information sent by the second node, the first node does not select the second node to perform positioning.

In some embodiments, content of the second information includes at least one of the following:
Zone information of the second node;
an RSRP value measured by the second node;
movement state information of the second node;
a network coverage state of the second node;
a PC5 unicast link state of the second node; or
positioning-related capability information of the second node.

It should be noted that, for understanding of the content of the second information, reference may be made to the description in the embodiment shown in FIG. 4, and details are not described herein again.

In some embodiments, the sending, by the second node, second information to the first node includes at least one of the following:
in a case that the first information is carried in a Direct Communication Request message, sending, by the second node, the second information to the first node through a Direct Communication Accept message;
in a case that the first information is carried in a newly defined request message for establishing a PC5 unicast link, sending, by the second node, the second information to the first node through a newly defined request message for responding to establishment of the PC5 unicast link; or
in a case that the first information is carried in a message related to establishment security of the second node, sending, by the second node, the second information to the first node through a message related to establishment security of the first node.

It may be understood that, in a case that the first information is carried in a request message for establishing a PC5 unicast link, the second information is carried in a corresponding response message.

In some embodiments, the sending, by the second node, second information to the first node includes at least one of the following:
in a case that the first information is carried in a UECapabilityEnquirySidelink message, sending, by the second node, the second information to the first node through a UECapabilityInformationSidelink message;
in a case that the first information is carried in an RRCReconfigurationSidelink message, sending, by the second node, the second information to the first node through an RRCReconfigurationCompleteSidelink message;
in a case that the first information is carried in a Link Identifier Update Request message, sending, by the second node, the second information to the first node through a Link Identifier Update Response message;
in a case that the first information is carried in a Disconnect Request message, sending, by the second node, the second information to the first node through a Disconnect Response message;
in a case that the first information is carried in a Link Modification Request message, sending, by the second node, the second information to the first node through a Link Modification Accept message;
in a case that the first information is carried in a Keep-alive message, sending, by the second node, the second information to the first node through a Keep-alive Ack message;
in a case that the first information is carried in a newly defined PC5-RRC message, sending, by the second node, the second information to the first node through the newly defined PC5-RRC message; or
in a case that the first information is carried in a newly defined PC5-S message, sending, by the second node, the second information to the first node through the newly defined PC5-S message.

It may be understood that, in a case that the first information is carried in the foregoing messages, the second information is carried in response messages corresponding to the messages.

In some embodiments, the second node sends the second information to the first node through at least one of the following:
a Direct Communication Request message;
a newly defined request message for establishing a PC5 unicast link; or
a message related to establishment security of the first node; or
a broadcast message other than a request message for establishing a PC5 unicast link.

In some embodiments, in a case that the first node sends the first information to the second node in a broadcast manner, the second node may send the second information to the first node through the foregoing messages.

In the embodiments of this application, various manners for performing information exchange between the first node and the second node are provided, so that the flexibility of selecting a node used for performing sidelink positioning may be improved.

It should be noted that, an execution entity of the node selection method provided in the embodiments of this application may be a node selection apparatus or a control module configured to perform the node selection method in the node selection apparatus. The node selection apparatus provided in the embodiments of this application is described by using an example in which the node selection apparatus performs the node selection method in the embodiments of this application.

FIG. 6 is a first schematic structural diagram of a node selection apparatus according to an embodiment of this application. As shown in FIG. 6, the node selection apparatus 600 includes:
a selection unit 601, configured to select a second node, where the second node is used for performing positioning together with a first node.

In the embodiments of this application, the first node selects the second node, where the second node is a node used for performing positioning together with the first node. This application may be applied to the method of implementing positioning by sending and measuring a positioning reference signal based on a sidelink between terminals, thereby implementing sidelink positioning.

In some embodiments, the second node includes at least one of the following:
a node that does not need to establish a connection to the first node; or
a node that needs to establish a connection to the first node.

In some embodiments, in a case that the second node is a node that needs to establish a connection to the first node, the step that the first node selects the second node is performed in a process of establishing a connection between the first node and the second node, and/or after the process of establishing a connection between the first node and the second node.

In some embodiments, the first node includes at least one of the following:
a terminal;
a base station; or
a core network function; and
the second node includes at least one of the following:
a terminal;
a base station; or
a core network function.

In some embodiments, the establishing a connection between the first node and the second node includes one of the following:
in a case that one of the first node and the second node is a terminal and the other is a base station, establishing a radio resource control RRC connection between the first node and the second node;
in a case that both the first node and the second node are terminals, establishing a PC5 unicast link connection PC5 unicast link between the first node and the second node; and/or in a case that both the first node and the second node are terminals, establishing a PC5-RRC connection between the first node and the second node; or
in a case that one of the first node and the second node is a terminal and the other is a core network function, establishing a non-access stratum NAS connection between the first node and the second node.

In some embodiments, the establishing a PC5 unicast link connection between the first node and the second node includes least one of the following:
sending, by the first node, a request message for establishing a PC5 unicast link to the second node in a PC5 broadcast manner; or
sending, by the first node, a request message for establishing a PC5 unicast link to the second node in a PC5 unicast manner.

In some embodiments, in a case that the step that the first node selects the second node is performed in the process of establishing a connection between the first node and the second node, first information is carried in the request message for establishing a PC5 unicast link.

In the embodiments of this application, that the first node selects the second node is performed in the process of establishing a PC5 unicast link connection between the first node and the second node, the first node sends the first information to the second node, so that the first node selects the second node according to feedback of the second node, where the first information is carried in the request message for establishing a PC5 unicast link, so that a node used for performing positioning may be selected.

In some embodiments, the apparatus further includes a first receiving unit, configured to receive second information sent by the second node.

In some embodiments, the first receiving unit is configured to:
receive the second information sent by the second node in a case that a first condition is met.

In the embodiments of this application, the first node may determine whether to select the second node according to reception of the second information, so that a node used for performing sidelink positioning may be selected.

In some embodiments, the request message for establishing a PC5 unicast link includes at least one of the following:
a direct communication request Direct Communication Request message;
a newly defined request message for establishing a PC5 unicast link; or
a message related to establishment security of the second node.

In some embodiments, the second information may be carried in different messages, and for example, at least one of the following may be included:
in a case that the request message for establishing a PC5 unicast link is a Direct Communication Request message, the second information is carried in a direct communication accept Direct Communication Accept message;
in a case that the request message for establishing a PC5 unicast link is a newly defined request message for establishing a PC5 unicast link, the second information is carried in a newly defined request message for responding to establishment of the PC5 unicast link; or
in a case that the request message for establishing a PC5 unicast link is a message related to establishment security of the second node, the second information is carried in a message related to establishment security of the first node.

In the embodiments of this application, various manners for performing information exchange between the first node and the second node are provided, so that the flexibility of selecting a node used for performing sidelink positioning may be improved.

In some embodiments, in a case that the step that the first node selects the second node is performed after the process of establishing a connection between the first node and the second node, the apparatus further includes:
a first sending unit, configured to send first information to the second node.

In the embodiments of this application, after a connection is established between the first node and the second node, the first node sends the first information to the second node. The first information is information sent by the first node to the second node to cause the first node to select the second node used for performing positioning according to feedback of the second node, so that a node used for performing sidelink positioning may be selected.

In some embodiments, the apparatus further includes a second receiving unit, configured to receive second information sent by the second node.

In some embodiments, the second receiving unit is configured to:
receive the second information sent by the second node in a case that a first condition is met.

In the embodiments of this application, a node used for performing sidelink positioning may be selected through exchange of the second information.

In some embodiments, the first sending unit sends the first information to the second node through at least one of the following:
a UECapabilityEnquirySidelink message;
an RRCReconfigurationSidelink message;
a Link Identifier Update Request message;
a Link Identifier Update Ack message;
a Disconnect Request message;
a Link Modification Request message;
a Keep-alive message;
a newly defined PC5-RRC message; or
a newly defined PC5-S message.

In some embodiments, the second information may be carried in different messages, and for example, at least one of the following may be included:
in a case that the first node sends the first information to the second node through the UECapabilityEnquirySidelink message, the second information is carried in a UECapabilityInformationSidelink message;
in a case that the first node sends the first information to the second node through the RRCReconfigurationSidelink message, the second information is carried in an RRCReconfigurationCompleteSidelink message;
in a case that the first node sends the first information to the second node through the Link Identifier Update Request message, the second information is carried in a Link Identifier Update Response message;
in a case that the first node sends the first information to the second node through the Disconnect Request message, the second information is carried in a Disconnect Response message;
in a case that the first node sends the first information to the second node through the Link Modification Request message, the second information is carried in a Link Modification Accept message;
in a case that the first node sends the first information to the second node through the Keep-alive message, the second information is carried in a Keep-alive Ack message;
in a case that the first node sends the first information to the second node through the newly defined PC5-RRC message, the second information is carried in the newly defined PC5-RRC message; or
in a case that the first node sends the first information to the second node through the newly defined PC5-S message, the second information is carried in the newly defined PC5-S message.

In the embodiments of this application, various manners for performing information exchange between the first node and the second node are provided, so that the flexibility of selecting a node used for performing sidelink positioning may be improved.

In some embodiments, in a case that the step that the first node selects the second node is performed in the process of establishing a connection between the first node and the second node, or in a case that the second node does not need to establish a connection to the first node, the apparatus further includes:
a broadcasting unit, configured to broadcast first information to the second node.

In the embodiments of this application, the first node broadcasts the first information to the second node. The first information is information sent by the first node to the second node to cause the first node to select the second node used for performing positioning according to feedback of the second node, so that a node used for performing sidelink positioning may be selected.

In some embodiments, the apparatus further includes a third receiving unit, configured to receive second information sent by the second node.

In some embodiments, the third receiving unit is configured to:
receive the second information sent by the second node in a case that a first condition is met.

In the embodiments of this application, the first node receives the second information sent by the second node after broadcasting the first information to the second node, and a node used for performing sidelink positioning may be selected through information exchange between the first node and the second node.

In some embodiments, the second information may be carried in different messages, and for example, at least one of the following may be included:
in a case that the step that the first node selects the second node is performed in the process of establishing a connection between the first node and the second node, the second information is carried in a Direct Communication Request message;
in a case that the step that the first node selects the second node is performed in the process of establishing a connection between the first node and the second node, the second information is carried in a newly defined request message for establishing a PC5 unicast link;
in a case that the step that the first node selects the second node is performed in the process of establishing a connection between the first node and the second node, the second information is carried in a message related to establishment security of the first node; or
in a case that the second node does not need to establish a connection to the first node, the second information is carried in a broadcast message other than a request message for establishing a PC5 unicast link.

In the embodiments of this application, various manners for performing information exchange between the first node and the second node are provided, so that the flexibility of selecting a node used for performing sidelink positioning is improved.

In some embodiments, content of the first information includes at least one of the following:
a first requirement;
positioning-related information;
information about the first node; or
requesting for information about the second node.

In the embodiments of this application, the first information includes a requirement on the second node and/or positioning-related information, and a node used for performing sidelink positioning may be selected through exchange of the positioning-related information.

In some embodiments, the first condition includes at least one of the following:
in a case that the first information includes a first requirement, the second node meets the first requirement in the first information; or
in a case that the first information includes positioning-related information, the second node is interested in the positioning-related information in the first information.

In some embodiments, content of the second information includes at least one of the following:
Zone information of the second node;
an RSRP value measured by the second node;
movement state information of the second node;
a network coverage state of the second node;
a PC5 unicast link state of the second node; or
positioning-related capability information of the second node.

In the embodiments of this application, the second information includes Zone information, movement state information, a network coverage state, a PC5 unicast link state, and positioning-related capability information, and a node used for performing sidelink positioning may be selected through exchange of the second information.

In some embodiments, the first requirement includes at least one of the following:
a capability requirement on the second node;
a reference signal receiving power RSRP threshold value;
a requirement on zone Zone information of the second node;
a movement state requirement on the second node;
a network coverage state requirement on the second node; or
a PC5 unicast link state requirement on the second node.

In some embodiments, the positioning-related information includes at least one of the following:
positioning precision/accuracy;
positioning integrity;
a positioning type;
a positioning update cycle; or
a positioning technology.

In some embodiments, the information about the first node or the information about the second node includes at least one of the following:
Zone information of the first node or the second node;
movement state information;
a network coverage state;
a PC5 unicast link state; or
positioning-related capability information.

In some embodiments, the capability requirement on the second node includes at least one of the following:
having an absolute positioning capability;
having a relative positioning capability;
having a radio access technology-dependent RAT-dependent positioning capability;
having a radio access technology-independent RAT-independent positioning capability;
having a capability of performing positioning through a sidelink;
positioning precision; or
a capability having positioning integrity.

In some embodiments, the movement state requirement on the second node includes at least one of the following:
being in a static state;
being in a moving state;
a static state is prior to a moving state;
a movement speed is not higher than a first threshold;
a movement speed is a value in a set;
a movement speed is not lower than a second threshold; or
a level of a movement speed.

In some embodiments, the network coverage state requirement on the second node includes at least one of the following:
the second node needs to be located in a coverage range of a base station; or
the second node does not need to be located in a coverage range of a base station.

In some embodiments, the PC5 unicast link state requirement on the second node includes at least one of the following:
needing to have established a PC5 unicast link to other terminals other than the first node;
not needing to have established a PC5 unicast link to other terminals other than the first node;
a quantity of other terminals to which a PC5 unicast link has been established is not lower than a third threshold;
a quantity of other terminals to which a PC5 unicast link has been established is not higher than a fourth threshold; or
a set/interval of a quantity of other terminals to which a PC5 unicast link has been established.

In some embodiments, the movement state information includes at least one of the following:
a static state or a moving state;
a movement speed value;
a level of a movement speed;
a movement speed is not lower than a fifth threshold and/or not higher than a sixth threshold; or
an interval of a movement speed value.

In some embodiments, the network coverage state includes at least one of the following:
being located in a coverage range of a base station; or
not being located in a coverage range of a base station.

In some embodiments, the PC5 unicast link state includes at least one of the following:
having established a PC5 unicast link to other terminals or having not established a PC5 unicast link to other terminals;
in a case of being a PC5 unicast link state of the second node, having established a PC5 unicast link to other terminals other than the first node or having not established a PC5 unicast link to other terminals other than the first node;
a quantity of other terminals to which a PC5 unicast link has been established is not lower than a seventh threshold;
in a case of being a PC5 unicast link state of the second node, a quantity of other terminals other than the first node to which a PC5 unicast link has been established is not lower than an eighth threshold;
a quantity of other terminals to which a PC5 unicast link has been established is not higher than a ninth threshold;
in a case of being a PC5 unicast link state of the second node, a quantity of other terminals other than the first node to which a PC5 unicast link has been established is not higher than a tenth threshold;
a set of a quantity of other terminals to which a PC5 unicast link has been established; or
in a case of being a PC5 unicast link state of the second node, a set of a quantity of other terminals other than the first node to which a PC5 unicast link has been established.

In some embodiments, the positioning-related capability information includes at least one of the following:
having an absolute positioning capability;
having a relative positioning capability;
having an RAT-dependent positioning capability;
having an RAT-independent positioning capability;
having a capability of performing positioning through a sidelink;
positioning precision; or
a capability having positioning integrity.

In some embodiments, that the first node selects the second node includes:
selecting, by the first node, the second node according to a first rule, where
the first rule is agreed on in a protocol and/or depends on an implementation of the first node.

In the embodiments of this application, the first node selects the second node according to the first rule, so that an effect of selecting a node used for performing sidelink positioning may be ensured.

In some embodiments, the apparatus further includes a second sending unit, configured to send third information to the second node.

In some embodiments, that the first node sends the third information to the second node includes at least one of the following:
sending, by the first node, the third information to a selected second node; or
sending, by the first node, the third information to an unselected second node.

In some embodiments, the third information includes at least one of the following:
in a case that the first node sends the third information to a selected second node, information used for indicating that the second node is selected by the first node as a node used for performing positioning;
in a case that the first node sends the third information to an unselected second node, information used for indicating that the second node is not selected by the first node as a node used for performing positioning;
information used for indicating that the second node is not selected by the first node as a node used for performing positioning; or
information used for indicating that the second node is selected by the first node as a node used for performing positioning.

In the embodiments of this application, after selecting the second node, the first node sends notification information to a corresponding node, so that an effect of selecting a node used for performing sidelink positioning may be ensured.

In some embodiments, that the first node selects the second node includes:
selecting, by the first node, the second node according to first indication information sent by a third node.

In some embodiments, the third node is at least one of the following:
a base station; or
a core network function.

In the embodiments of this application, the terminal may directly select the second node according to indication of the base station and/or the core network function, so that a node used for performing sidelink positioning may be selected conveniently.

In some embodiments, a quantity of the second nodes meets any one of the following:
unlimited; or
limited.

In the embodiments of this application, the first node may send the first information to a limited quantity of second nodes, and select at least one second node to implement sidelink positioning.

The node selection apparatus in the embodiments of this application may be an apparatus, an apparatus or an electronic device having an operating system, or may be a component, an integrated circuit, or a chip in a terminal. The apparatus or the electronic device may be a mobile terminal or may be a non-mobile terminal. For example, the mobile terminal may include but not limited to the types of the terminal 11 listed above, and the non-mobile terminal may be a server, a network attached storage, a Personal Computer (PC), a Television (TV), a teller machine, or an automatic machine, which is not specifically limited in the embodiments of this application.

The node selection apparatus provided in the embodiments of this application can implement the processed implemented in the method embodiment shown in FIG. 4 and achieve same technical effects, and to avoid repetition, details are not described herein again.

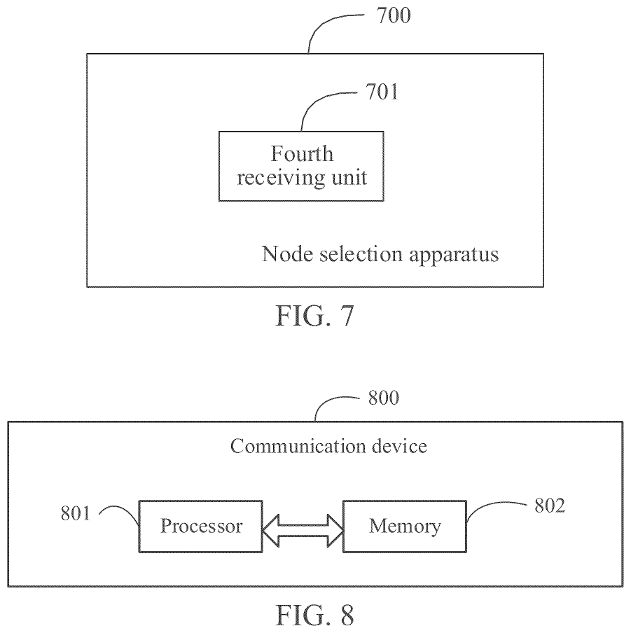

FIG. 7 is a second schematic structural diagram of a node selection apparatus according to an embodiment of this application. As shown in FIG. 7, the node selection apparatus 700 includes:
a fourth receiving unit 701, configured to receive first information sent by a first node.

In the embodiments of this application, the first information sent by the first node is received, and a second node is a node used for performing positioning together with the first node.

This application may be applied to the method of implementing positioning by sending and measuring a positioning reference signal based on a sidelink between terminals, thereby implementing sidelink positioning.

In some embodiments, the apparatus further includes a third sending unit, configured to send second information to the first node.

In some embodiments, the third sending unit is configured to:
send the second information to the first node in a case that a first condition is met.

In the embodiments of this application, the second information is fed back to the first node, so that the first node may determine whether to select the second node, and a node used for performing sidelink positioning may be selected.

In some embodiments, that the second node sends the second information to the first node includes at least one of the following:
in a case that the first information is carried in a Direct Communication Request message, sending, by the second node, the second information to the first node through a Direct Communication Accept message;
in a case that the first information is carried in a newly defined request message for establishing a PC5 unicast link, sending, by the second node, the second information to the first node through a newly defined request message for responding to establishment of the PC5 unicast link; or
in a case that the first information is carried in a message related to establishment security of the second node, sending, by the second node, the second information to the first node through a message related to establishment security of the first node.

In some embodiments, that the second node sends the second information to the first node includes at least one of the following:
in a case that the first information is carried in a UECapabilityEnquirySidelink message, sending, by the second node, the second information to the first node through a UECapabilityInformationSidelink message;
in a case that the first information is carried in an RRCReconfigurationSidelink message, sending, by the second node, the second information to the first node through an RRCReconfigurationCompleteSidelink message;
in a case that the first information is carried in a Link Identifier Update Request message, sending, by the second node, the second information to the first node through a Link Identifier Update Response message;
in a case that the first information is carried in a Disconnect Request message, sending, by the second node, the second information to the first node through a Disconnect Response message;
in a case that the first information is carried in a Link Modification Request message, sending, by the second node, the second information to the first node through a Link Modification Accept message;
in a case that the first information is carried in a Keep-alive message, sending, by the second node, the second information to the first node through a Keep-alive Ack message;
in a case that the first information is carried in a newly defined PC5-RRC message, sending, by the second node, the second information to the first node through the newly defined PC5-RRC message; or
in a case that the first information is carried in a newly defined PC5-S message, sending, by the second node, the second information to the first node through the newly defined PC5-S message.

In some embodiments, the second node sends the second information to the first node through at least one of the following:
a Direct Communication Request message;
a newly defined request message for establishing a PC5 unicast link; or
a message related to establishment security of the first node; or
a broadcast message other than a request message for establishing a PC5 unicast link.

In the embodiments of this application, various manners for performing information exchange between the first node and the second node are provided, so that the flexibility of selecting a node used for performing sidelink positioning is improved.

In some embodiments, content of the first information includes at least one of the following:
a first requirement;
positioning-related information;
information about the first node; or
requesting for information about the second node.

In the embodiments of this application, the first information includes a requirement on the second node and/or positioning-related information, and a node used for performing sidelink positioning may be selected through exchange of the positioning-related information.

In some embodiments, the first condition includes at least one of the following:
in a case that the first information includes a first requirement, the second node meets the first requirement in the first information; or
in a case that the first information includes positioning-related information, the second node is interested in the positioning-related information in the first information.

In some embodiments, content of the second information includes at least one of the following:
Zone information of the second node;
an RSRP value measured by the second node;
movement state information of the second node;
a network coverage state of the second node;
a PC5 unicast link state of the second node; or
positioning-related capability information of the second node.

In the embodiments of this application, the second information includes Zone information, movement state information, a network coverage state, a PC5 unicast link state, and positioning-related capability information, and a node used for performing sidelink positioning may be selected through exchange of the second information.

The node selection apparatus in the embodiments of this application may be an apparatus, an apparatus or an electronic device having an operating system, or may be a component, an integrated circuit, or a chip in a terminal. The apparatus or the electronic device may be a mobile terminal or may be a non-mobile terminal. For example, the mobile terminal may include but not limited to the types of the terminal 11 listed above, and the non-mobile terminal may be a server, a network attached storage, a PC, a TV, a teller machine, or an automatic machine, which is not specifically limited in the embodiments of this application.

The node selection apparatus provided in the embodiments of this application can implement the processed implemented in the method embodiment shown in FIG. 5 and achieve same technical effects, and to avoid repetition, details are not described herein again.

For example, as shown in FIG. 8, an embodiment of this application further provides a communication device 800, including a processor 801, a memory 802, and a program or instructions stored in the memory 802 and executable on the processor 801. For example, when the communication device 800 is a terminal, when the program or the instructions are executed by the processor 801, the processes of the node selection method embodiments are implemented, and same technical effects can be achieved. When the communication device 800 is a network side device, when the program or the instructions are executed by the processor 801, the processes of the node selection method embodiments are implemented, and same technical effects can be achieved. To avoid repetition, details are not described herein again.

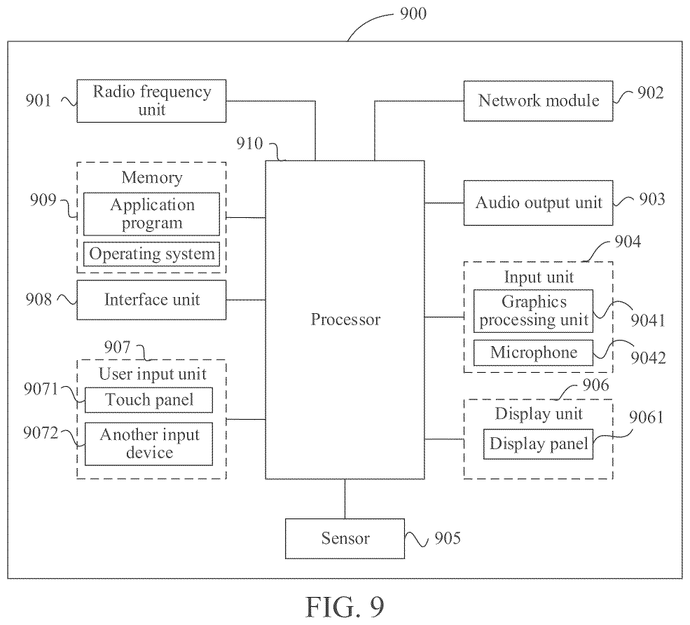

An embodiment of this application further provides a terminal, including a processor and a communication interface, where the processor is configured to select a second node. The second node is used for performing positioning together with a first node. The terminal embodiment corresponds to the foregoing terminal side method embodiments, implementation processes and implementations of the foregoing method embodiments may all be applied to the terminal embodiment, and same technical effects can be achieved. For example, FIG. 9 is a schematic diagram of a hardware structure of a terminal according to an embodiment of this application.

The terminal 900 includes, but is not limited to, at least a part of components such as a radio frequency unit 901, a network module 902, an audio output unit 903, an input unit 904, a sensor 905, a display unit 906, a user input unit 907, an interface unit 908, a memory 909, a processor 910, and the like.

A person skilled in the art may understand that, the terminal 900 may further include a power supply (such as a battery) for supplying power to the components. The power supply may be logically connected to the processor 910 through a power management system, thereby implementing functions such as charging, discharging, and power consumption management by using the power management system. A terminal structure shown in FIG. 9 does not constitute a limitation to the terminal, and the terminal may include more or fewer components than those shown in the figure, or some components may be combined, or a different component deployment may be used. Details are not described herein again.

It should be understood that, in the embodiments of this application, the input unit 904 may include a Graphics Processing Unit (GPU) 9041 and a microphone 9042. The graphics processing unit 9041 performs processing on image data of a static picture or a video that is obtained by an image capturing apparatus (for example, a camera) in a video capturing mode or an image capturing mode. The display unit 906 may include a display panel 9061, and the display panel 9061 may be configured in a form of a liquid crystal display, an organic light-emitting diode, or the like. The user input unit 907 may include a touch panel 9071 and another input device 9072. The touch panel 9071 is also referred to as a touch screen. The touch panel 9071 may include two parts: a touch detection apparatus and a touch controller. The another input device 9072 may include, but not limited to, a physical keyboard, a functional key (such as a volume control key or a switch key), a track ball, a mouse, and a joystick, which are not described herein.

In the embodiments of this application, after receiving downlink data from a network side device, the radio frequency unit 901 sends the downlink data to the processor 910 for processing; and sends UL data to the network side device. Generally, the radio frequency unit 901 includes, but is not limited to, an antenna, at least one amplifier, a transceiver, a coupler, a low noise amplifier, a duplexer, or the like.

The memory 909 may be configured to store a software program or instructions and various data. The memory 909 may mainly include a program or instruction storage region and a data storage region. The program or instruction storage region may store an operating system, an application program or instructions required by at least one function (for example, a sound playback function or an image display function), or the like. In addition, the memory 909 may include a high-speed random access memory and may further include a non-volatile memory. The non-volatile memory may be a Read-Only Memory (ROM), a Programmable ROM (PROM), an Erasable PROM (EPROM), an Electrically EPROM (EEPROM), or a flash memory. For example, the memory includes at least one magnetic disk storage device, a flash memory device, or other non-volatile solid-state storage devices.

The processor 910 may include one or more processing units. In some embodiments, the processor 910 may integrate an application processor and a modem processor, where the application processor mainly processes an operating system, a user interface, an application program or instructions, or the like, and the modem processor mainly processes wireless communication, for example, a baseband processor. In some alternatively embodiments, it may be understood that the foregoing modem processor may not be integrated into the processor 910.

The processor 910 is configured to select a second node. The second node is used for performing positioning together with a first node.

In the embodiments of this application, the first node selects the second node, where the second node is used for performing positioning together with the first node. This application may be applied to the method of implementing positioning by sending and measuring a positioning reference signal based on a sidelink between terminals, thereby implementing sidelink positioning.

In some embodiments, the second node includes at least one of the following:
a node that does not need to establish a connection to the first node; or
a node that needs to establish a connection to the first node.

In some embodiments, in a case that the second node is a node that needs to establish a connection to the first node, the step that the first node selects the second node is performed in a process of establishing a connection between the first node and the second node, and/or after the process of establishing a connection between the first node and the second node.

In some embodiments, the first node includes at least one of the following:
a terminal;
a base station; or
a core network function; and
the second node includes at least one of the following:
a terminal;
a base station; or
a core network function.

In some embodiments, the establishing a connection between the first node and the second node includes one of the following:
in a case that one of the first node and the second node is a terminal and the other is a base station, establishing a radio resource control RRC connection between the first node and the second node;
in a case that both the first node and the second node are terminals, establishing a PC5 unicast link connection PC5 unicast link between the first node and the second node; and/or in a case that both the first node and the second node are terminals, establishing a PC5-RRC connection between the first node and the second node; or
in a case that one of the first node and the second node is a terminal and the other is a core network function, establishing a non-access stratum NAS connection between the first node and the second node.

In some embodiments, the establishing a PC5 unicast link connection between the first node and the second node includes least one of the following:
sending, by the first node, a request message for establishing a PC5 unicast link to the second node in a PC5 broadcast manner; or
sending, by the first node, a request message for establishing a PC5 unicast link to the second node in a PC5 unicast manner.

In some embodiments, in a case that the step that the first node selects the second node is performed in the process of establishing a connection between the first node and the second node, first information is carried in the request message for establishing a PC5 unicast link.

In the embodiments of this application, the first node selects the second node in the process of establishing a PC5 unicast link connection between the first node and the second node, the first node sends the first information to the second node, so that the first node selects the second node according to feedback of the second node, where the first information is carried in the request message for establishing a PC5 unicast link, so that a node used for performing positioning may be selected.

In some embodiments, the radio frequency unit 901 is configured to receive second information sent by the second node.

In some embodiments, the radio frequency unit 901 is configured to:
receive the second information sent by the second node in a case that a first condition is met.

In the embodiments of this application, the first node may determine whether to select the second node according to reception of the second information, so that a node used for performing sidelink positioning may be selected.

In some embodiments, the request message for establishing a PC5 unicast link includes at least one of the following:
a direct communication request Direct Communication Request message;
a newly defined request message for establishing a PC5 unicast link; or
a message related to establishment security of the second node.

In some embodiments, the second information may be carried in different messages, and for example, at least one of the following may be included:
in a case that the request message for establishing a PC5 unicast link is a Direct Communication Request message, the second information is carried in a direct communication accept Direct Communication Accept message;
in a case that the request message for establishing a PC5 unicast link is a newly defined request message for establishing a PC5 unicast link, the second information is carried in a newly defined request message for responding to establishment of the PC5 unicast link; or
in a case that the request message for establishing a PC5 unicast link is a message related to establishment security of the second node, the second information is carried in a message related to establishment security of the first node.

In the embodiments of this application, various manners for performing information exchange between the first node and the second node are provided, so that the flexibility of selecting a node for performing positioning together with the first node may be improved.

In some embodiments, in a case that the step that the first node selects the second node is performed after the process of establishing a connection between the first node and the second node, the radio frequency unit 901 is further configured to send first information to the second node.

In the embodiments of this application, after a connection is established between the first node and the second node, the first node sends the first information to the second node. The first information is information sent by the first node to the second node to cause the first node to select the second node used for performing positioning according to feedback of the second node, so that a node used for performing sidelink positioning may be selected.

In some embodiments, the radio frequency unit 901 is further configured to receive second information sent by the second node.

In some embodiments, the radio frequency unit 901 is configured to:
receive the second information sent by the second node in a case that a first condition is met.

In the embodiments of this application, a node used for performing sidelink positioning may be selected through exchange of the second information.

In some embodiments, the radio frequency unit 901 sends the first information to the second node through at least one of the following:
a UECapabilityEnquirySidelink message;
an RRCReconfigurationSidelink message;
a Link Identifier Update Request message;
a Link Identifier Update Ack message;
a Disconnect Request message;
a Link Modification Request message;
a Keep-alive message;
a newly defined PC5-RRC message; or
a newly defined PC5-S message.

In some embodiments, the second information may be carried in different messages, and for example, at least one of the following may be included:
in a case that the first node sends the first information to the second node through the UECapabilityEnquirySidelink message, the second information is carried in a UECapabilityInformationSidelink message;
in a case that the first node sends the first information to the second node through the RRCReconfigurationSidelink message, the second information is carried in an RRCReconfigurationCompleteSidelink message;
in a case that the first node sends the first information to the second node through the Link Identifier Update Request message, the second information is carried in a Link Identifier Update Response message;
in a case that the first node sends the first information to the second node through the Disconnect Request message, the second information is carried in a Disconnect Response message;
in a case that the first node sends the first information to the second node through the Link Modification Request message, the second information is carried in a Link Modification Accept message;
in a case that the first node sends the first information to the second node through the Keep-alive message, the second information is carried in a Keep-alive Ack message;
in a case that the first node sends the first information to the second node through the newly defined PC5-RRC message, the second information is carried in the newly defined PC5-RRC message; or
in a case that the first node sends the first information to the second node through the newly defined PC5-S message, the second information is carried in the newly defined PC5-S message.

In the embodiments of this application, various manners for performing information exchange between the first node and the second node are provided, so that the flexibility of selecting a node used for performing sidelink positioning may be improved.

In some embodiments, in a case that the step that the first node selects the second node is performed in the process of establishing a connection between the first node and the second node, or in a case that the second node does not need to establish a connection to the first node, the radio frequency unit 901 is further configured to:
broadcast first information to the second node.

In the embodiments of this application, the first node broadcasts the first information to the second node. The first information is information sent by the first node to the second node to cause the first node to select the second node used for performing positioning according to feedback of the second node, so that a node used for performing sidelink positioning may be selected.

In some embodiments, the radio frequency unit 901 is further configured to receive second information sent by the second node.

The second information sent by the second node is received in a case that a first condition is met.

In some embodiments, the radio frequency unit 901 is configured to:
receive the second information sent by the second node in a case that a first condition is met.

In the embodiments of this application, the first node receives the second information sent by the second node after broadcasting the first information to the second node, and a node used for performing sidelink positioning may be selected through information exchange between the first node and the second node.

In some embodiments, the second information may be carried in different messages, and for example, at least one of the following may be included:
in a case that the step that the first node selects the second node is performed in the process of establishing a connection between the first node and the second node, the second information is carried in a Direct Communication Request message;
in a case that the step that the first node selects the second node is performed in the process of establishing a connection between the first node and the second node, the second information is carried in a newly defined request message for establishing a PC5 unicast link;
in a case that the step that the first node selects the second node is performed in the process of establishing a connection between the first node and the second node, the second information is carried in a message related to establishment security of the first node; or
in a case that the second node does not need to establish a connection to the first node, the second information is carried in a broadcast message other than a request message for establishing a PC5 unicast link.

In the embodiments of this application, various manners for performing information exchange between the first node and the second node are provided, so that the flexibility of selecting a node used for performing sidelink positioning is improved.

In some embodiments, content of the first information includes at least one of the following:
a first requirement;
positioning-related information;
information about the first node; or
requesting for information about the second node.

In the embodiments of this application, the first information includes a requirement on the second node and/or positioning-related information, and a node used for performing sidelink positioning may be selected through exchange of the positioning-related information.

In some embodiments, the first condition includes at least one of the following:
in a case that the first information includes a first requirement, the second node meets the first requirement in the first information; or
in a case that the first information includes positioning-related information, the second node is interested in the positioning-related information in the first information.

In some embodiments, content of the second information includes at least one of the following:
Zone information of the second node;
an RSRP value measured by the second node;
movement state information of the second node;
a network coverage state of the second node;
a PC5 unicast link state of the second node; or
positioning-related capability information of the second node.

In the embodiments of this application, the second information includes Zone information, movement state information, a network coverage state, a PC5 unicast link state, and positioning-related capability information, and a node used for performing sidelink positioning may be selected through exchange of the second information.

In some embodiments, the first requirement includes at least one of the following:
a capability requirement on the second node;
a reference signal receiving power RSRP threshold value;
a requirement on zone Zone information of the second node;
a movement state requirement on the second node;
a network coverage state requirement on the second node; or
a PC5 unicast link state requirement on the second node.

In some embodiments, the positioning-related information includes at least one of the following:
positioning precision/accuracy;
positioning integrity;
a positioning type;
a positioning update cycle; or
a positioning technology.

In some embodiments, the information about the first node or the information about the second node includes at least one of the following:
Zone information of the first node or the second node;
movement state information;
a network coverage state;
a PC5 unicast link state; or
positioning-related capability information.

In some embodiments, the capability requirement on the second node includes at least one of the following:
having an absolute positioning capability;
having a relative positioning capability;
having a radio access technology-dependent RAT-dependent positioning capability;
having a radio access technology-independent RAT-independent positioning capability;
having a capability of performing positioning through a sidelink;
positioning precision; or
a capability having positioning integrity.

In some embodiments, the movement state requirement on the second node includes at least one of the following:
being in a static state;
being in a moving state;
a static state is prior to a moving state;
a movement speed is not higher than a first threshold;
a movement speed is a value in a set;
a movement speed is not lower than a second threshold; or
a level of a movement speed.

In some embodiments, the network coverage state requirement on the second node includes at least one of the following:
the second node needs to be located in a coverage range of a base station; or
the second node does not need to be located in a coverage range of a base station.

In some embodiments, the PC5 unicast link state requirement on the second node includes at least one of the following:
needing to have established a PC5 unicast link to other terminals other than the first node;
not needing to have established a PC5 unicast link to other terminals other than the first node;
a quantity of other terminals to which a PC5 unicast link has been established is not lower than a third threshold;
a quantity of other terminals to which a PC5 unicast link has been established is not higher than a fourth threshold; or
a set/interval of a quantity of other terminals to which a PC5 unicast link has been established.

In some embodiments, the movement state information includes at least one of the following:
a static state or a moving state;
a movement speed value;
a level of a movement speed;
a movement speed is not lower than a fifth threshold and/or not higher than a sixth threshold; or
an interval of a movement speed value.

In some embodiments, the network coverage state includes at least one of the following:
being located in a coverage range of a base station; or
not being located in a coverage range of a base station.

In some embodiments, the PC5 unicast link state includes at least one of the following:
having established a PC5 unicast link to other terminals or having not established a PC5 unicast link to other terminals;
in a case of being a PC5 unicast link state of the second node, having established a PC5 unicast link to other terminals other than the first node or having not established a PC5 unicast link to other terminals other than the first node;
a quantity of other terminals to which a PC5 unicast link has been established is not lower than a seventh threshold;
in a case of being a PC5 unicast link state of the second node, a quantity of other terminals other than the first node to which a PC5 unicast link has been established is not lower than an eighth threshold;
a quantity of other terminals to which a PC5 unicast link has been established is not higher than a ninth threshold;
in a case of being a PC5 unicast link state of the second node, a quantity of other terminals other than the first node to which a PC5 unicast link has been established is not higher than a tenth threshold;
a set of a quantity of other terminals to which a PC5 unicast link has been established; or
in a case of being a PC5 unicast link state of the second node, a set of a quantity of other terminals other than the first node to which a PC5 unicast link has been established.

In some embodiments, the positioning-related capability information includes at least one of the following:
having an absolute positioning capability;
having a relative positioning capability;
having an RAT-dependent positioning capability;
having an RAT-independent positioning capability;
having a capability of performing positioning through a sidelink;
positioning precision; or
a capability having positioning integrity.

In some embodiments, that the first node selects the second node includes:
selecting, by the first node, the second node according to a first rule, where
the first rule is agreed on in a protocol and/or depends on an implementation of the first node.

In the embodiments of this application, the first node selects the second node according to the first rule, so that an effect of selecting a node used for performing positioning together with the first node may be ensured.

In some embodiments, the radio frequency unit 901 is further configured to perform at least one of the following:
send third information to the second node.

In some embodiments, that the first node sends the third information to the second node includes at least one of the following:
sending, by the first node, the third information to a selected second node; or
sending, by the first node, the third information to an unselected second node.

In some embodiments, the third information includes at least one of the following:
in a case that the first node sends the third information to a selected second node, information used for indicating that the second node is selected by the first node as a node used for performing positioning;
in a case that the first node sends the third information to an unselected second node, information used for indicating that the second node is not selected by the first node as a node used for performing positioning;
information used for indicating that the second node is not selected by the first node as a node used for performing positioning; or
information used for indicating that the second node is selected by the first node as a node used for performing positioning.

In the embodiments of this application, after selecting the second node, the first node sends notification information to a corresponding node, so that an of effect of selecting a node used for performing sidelink positioning may be ensured.

In some embodiments, that the first node selects the second node includes:
selecting, by the first node, the second node according to first indication information sent by a third node.

In some embodiments, the third node is at least one of the following:
a base station; or
a core network function.

In the embodiments of this application, the terminal may directly select the second node according to indication of the base station and/or the core network function, so that a node used for performing sidelink positioning may be selected conveniently.

In some embodiments, a quantity of the second nodes meets any one of the following:
unlimited; or
limited.

In the embodiments of this application, the first node may send the first information to a limited quantity of second nodes, and select at least one second node to implement sidelink positioning.

An embodiment of this application further provides a terminal, including a processor and a communication interface, where the communication interface is configured to receive first information sent by a first node. The terminal embodiment corresponds to the foregoing terminal side method embodiments, implementation processes and implementations of the foregoing method embodiments may all be applied to the terminal embodiment, and same technical effects can be achieved. For example, the terminal may be the terminal shown in FIG. 9, where the radio frequency unit 901 is configured to receive the first information sent by the first node.

In the embodiments of this application, the first information sent by the first node is received, and a second node is a node used for performing positioning on the first node. This application may be applied to the method of implementing positioning by sending and measuring a positioning reference signal based on a sidelink between terminals, thereby implementing sidelink positioning.

In some embodiments, the radio frequency unit 901 is further configured to send second information to the first node.

In some embodiments, the radio frequency unit 901 is configured to send the second information to the first node in a case that a first condition is met.

In the embodiments of this application, the second information is fed back to the first node, so that the first node may determine whether to select the second node, and a node used for performing sidelink positioning may be selected.

In some embodiments, that the second node sends the second information to the first node includes at least one of the following:
in a case that the first information is carried in a Direct Communication Request message, sending, by the second node, the second information to the first node through a Direct Communication Accept message;
in a case that the first information is carried in a newly defined request message for establishing a PC5 unicast link, sending, by the second node, the second information to the first node through a newly defined request message for responding to establishment of the PC5 unicast link; or
in a case that the first information is carried in a message related to establishment security of the second node, sending, by the second node, the second information to the first node through a message related to establishment security of the first node.

In some embodiments, that the second node sends the second information to the first node includes at least one of the following:
in a case that the first information is carried in a UECapabilityEnquirySidelink message, sending, by the second node, the second information to the first node through a UECapabilityInformationSidelink message;
in a case that the first information is carried in an RRCReconfigurationSidelink message, sending, by the second node, the second information to the first node through an RRCReconfigurationCompleteSidelink message;
in a case that the first information is carried in a Link Identifier Update Request message, sending, by the second node, the second information to the first node through a Link Identifier Update Response message;
in a case that the first information is carried in a Disconnect Request message, sending, by the second node, the second information to the first node through a Disconnect Response message;
in a case that the first information is carried in a Link Modification Request message, sending, by the second node, the second information to the first node through a Link Modification Accept message;
in a case that the first information is carried in a Keep-alive message, sending, by the second node, the second information to the first node through a Keep-alive Ack message;
in a case that the first information is carried in a newly defined PC5-RRC message, sending, by the second node, the second information to the first node through the newly defined PC5-RRC message; or
in a case that the first information is carried in a newly defined PC5-S message, sending, by the second node, the second information to the first node through the newly defined PC5-S message.

In some embodiments, the second node sends the second information to the first node through at least one of the following:
a Direct Communication Request message;
a newly defined request message for establishing a PC5 unicast link; or
a message related to establishment security of the first node; or
a broadcast message other than a request message for establishing a PC5 unicast link.

In the embodiments of this application, various manners for performing information exchange between the first node and the second node are provided, so that the flexibility of selecting a node used for performing sidelink positioning is improved.

In some embodiments, content of the first information includes at least one of the following:
a first requirement;
positioning-related information;
information about the first node; or
requesting for information about the second node.

In the embodiments of this application, the first information includes a requirement on the second node and/or positioning-related information, and a node used for performing sidelink positioning may be selected through exchange of the positioning-related information.

In some embodiments, the first condition includes at least one of the following:
in a case that the first information includes a first requirement, the second node meets the first requirement in the first information; or
in a case that the first information includes positioning-related information, the second node is interested in the positioning-related information in the first information.

In some embodiments, content of the second information includes at least one of the following:
Zone information of the second node;
an RSRP value measured by the second node;
movement state information of the second node;
a network coverage state of the second node;
a PC5 unicast link state of the second node; or
positioning-related capability information of the second node.

In the embodiments of this application, the second information includes Zone information, movement state information, a network coverage state, a PC5 unicast link state, and positioning-related capability information, and a node used for performing sidelink positioning may be selected through exchange of the second information.

An embodiment of this application further provides a network side device, including a processor and a communication interface, where the processor is configured to select a second node. The second node is used for performing positioning together with a first node. The network side device embodiment corresponds to the foregoing network side device method embodiments, implementation processes and implementations of the foregoing method embodiments may all be applied to the network side device embodiment, and same technical effects can be achieved.

For example, an embodiment of this application further provides a network side device, including a processor and a communication interface, where the communication interface is configured to receive first information sent by a first node. The network side device embodiment corresponds to the foregoing network side device method embodiments, implementation processes and implementations of the foregoing method embodiments may all be applied to the network side device embodiment, and same technical effects can be achieved.

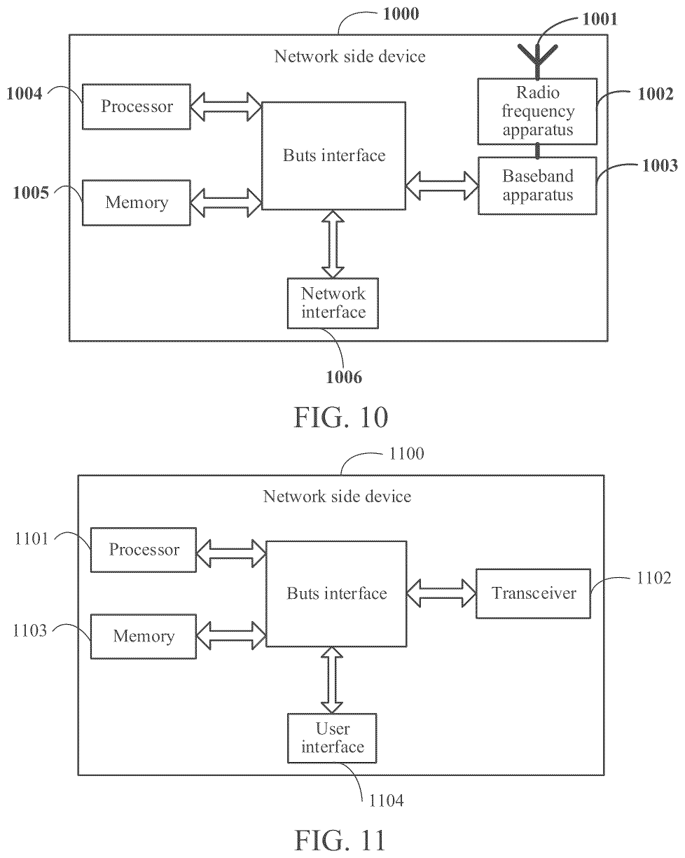

For example, an embodiment of this application further provides a network side device. As shown in FIG. 10, the network side device 1000 includes an antenna 1001, a radio frequency apparatus 1002, and a baseband apparatus 1003. The antenna 1001 is connected to the radio frequency apparatus 1002. In an uplink direction, the radio frequency apparatus 1002 receives information by using the antenna 1001, and sends the received information to the baseband apparatus 1003 for processing. In a downlink direction, the baseband apparatus 1003 processes to-be-sent information, and sends the information to the radio frequency apparatus 1002. The radio frequency apparatus 1002 processes the received information and sends the information to the outside by using the antenna 1001.

A frequency band processing apparatus may be located in the baseband apparatus 1003, the method performed by the network side device in the foregoing embodiments may be implemented in the baseband apparatus 1003, and the baseband apparatus 1003 includes a processor 1004 and a memory 1005.

The baseband apparatus 1003 may include, for example, at least one baseband plate. A plurality of chips are disposed on the baseband plate. As shown in FIG. 10, one of the plurality of chips is, for example, the processor 1004, and is connected to the memory 1005, to invoke a program in the memory 1005 to perform operations of the network side device in the foregoing method embodiments.

The baseband apparatus 1003 may further include a network interface 1006, configured to exchange information with the radio frequency apparatus 1002. The interface is, for example, a Common Public Radio Interface (CPRI).

For example, the network side device in this embodiment of the present application further includes: instructions or a program stored in the memory 1005 and executable on the processor 1004, and the processor 1004 invokes the instructions or the program in the memory 1005 to perform the method performed by the modules shown in FIG. 6 or FIG. 7 and achieves same technical effects. To avoid repetition, details are not described herein again.

For example, an embodiment of this application further provides a network side device. As shown in FIG. 11, the network side device 1100 includes a processor 1101, a transceiver 1102, a memory 1103, a user interface 1104, and a bus interface.

In this embodiment of the present application, the network side device 1100 further includes a computer program stored in the memory 1103 and executable on the processor 1101, the computer program is executed by the processor 1101 to perform the method performed by the modules shown in FIG. 6 or FIG. 7, and same technical effects are achieved. To avoid repetition, details are not described herein again.

In FIG. 11, a bus architecture may include any quantity of interconnected buses and bridges, and connects various circuits that are of one or more processors represented by the processor 1101 and of a memory represented by the memory 1103. The bus architecture may further connect various other circuits that are of a peripheral, a voltage regulator, a power management circuit, and the like. This is well known in the art, and therefore, no further description is provided in this specification. The bus interface provides an interface. The transceiver 1102 may be a plurality of components, including a transmitter and a receiver, and providing units for communicating with various other apparatuses on a transmission medium. For different UEs, the user interface 1104 may be an interface capable of externally or internally connecting a required device, the connected device includes, but not limited to, a keypad, a display, a speaker, a microphone, a joystick, or the like.

The processor 1101 is responsible for the management of the bus architecture and normal processing, and the memory 1103 may store data used when the processor 1101 performs an operation.

An embodiment of this application further provides a readable storage medium, storing a program or instructions. When the program or the instructions are executed by a processor, the processes of the foregoing node selection method embodiments are implemented, and same technical effects can be achieved. To avoid repetition, details are not described herein again.

The processor is a processor in the terminal described in the foregoing embodiments. The readable storage medium includes a computer-readable storage medium, for example, a computer ROM, a Random Access Memory (RAM), a magnetic disk, an optical disc, or the like.

An embodiment of this application further provides a chip, including a processor and a communication interface. The communication interface is coupled to the processor, the processor is configured to execute a program or instructions, to implement the processes of the foregoing node selection method embodiments, and same technical effects can be achieved. To avoid repetition, details are not described herein again.

It should be understood that, the chip mentioned in this embodiment of this application may also be referred to as a system-level chip, a system chip, a chip system, a system on chip, or the like.

An embodiment of this application further provides a computer program/program product. The computer program/program product is stored in a non-transitory storage medium, the program/program product is executed by at least one processor to implement the processes of the foregoing system message report reporting method embodiments, and same technical effects can be achieved. To avoid repetition, details are not described herein again.

It should be noted that, the term “include”, “comprise”, or any other variation thereof in this specification is intended to cover a non-exclusive inclusion. Therefore, a process, method, object, or apparatus that includes a series of elements not only includes such elements, but also includes other elements that are not expressly listed, or may include elements inherent to the process, method, object, or apparatus. Without more limitations, elements defined by the sentence “include a/an . . . ” does not exclude that there are still other same elements in the process, method, object, or apparatus that includes the element. In addition, it should be noted that, the method and apparatus ranges in the implementations of this application are not limited to performing functions according to a shown or discussed sequence, but may further include performing functions in a basically simultaneously manner or in a reverse sequence based on involved functions. For example, the described method may be performed according to a sequence different from the described sequence, and various steps may be further added, omitted, or combined. In addition, features described with reference to some examples may also be combined in other examples.

Through the description of the foregoing implementations, a person skilled in the art may clearly understand that the methods in the foregoing embodiments may be implemented by software and a necessary general hardware platform, and, may also be implemented by hardware. Based on such an understanding, the technical solutions in this application entirely or the part contributing to the related art may be implemented in the form of a software product. The computer software product is stored in a storage medium (for example, a ROM/RAM, a magnetic disk, or an optical disc), and includes several instructions for instructing a terminal (which may be a mobile phone, a computer, a server, a network device, or the like) to perform the methods described in the embodiments of this application.

The embodiments of this application are described above with reference to the accompanying drawings. However, this application is not limited to the foregoing specific implementations. The foregoing specific implementations are merely illustrative instead of limitative. Enlightened by this application, a person of ordinary skill in the art can make many forms without departing from the idea of this application and the protection scope of the claims, and all of the forms fall within the protection of this application.

What is claimed is:

1. A node selection method, comprising:
selecting, by a first node, a second node, wherein the second node is used for performing positioning together with the first node,
wherein:
the first node is at least one of the following:
a terminal;
a base station, or
a core network function;
the second node is at least one of the following:
a terminal;
a base station, or
a core network function; and
the second node comprises at least one of the following:
a node that does not need to establish a connection to the first node; or
a node that needs to establish a connection to the first node,
wherein when the second node is a node that needs to establish a connection to the first node, selecting, by the first node, the second node is performed either in a process of establishing a connection between the first node and the second node, or after the process of establishing a connection between the first node and the second node.

2. The node selection method according to claim 1, wherein establishing the connection between the first node and the second node comprises one of the following:
when one of the first node and the second node is a terminal and the other is a base station, establishing a Radio Resource Control (RRC) connection between the first node and the second node;
when both the first node and the second node are terminals, establishing a PC5 unicast link connection between the first node and the second node; or when both the first node and the second node are terminals, establishing a PC5-RRC connection between the first node and the second node; or
when one of the first node and the second node is a terminal and the other is a core network function, establishing a Non-Access Stratum (NAS) connection between the first node and the second node.

3. The node selection method according to claim 2, wherein establishing the PC5 unicast link connection between the first node and the second node comprises at least one of the following:
sending, by the first node, a request message for establishing a PC5 unicast link to the second node in a PC5 broadcast manner; or
sending, by the first node, a request message for establishing a PC5 unicast link to the second node in a PC5 unicast manner.

4. The node selection method according to claim 3, wherein when selecting, by the first node, the second node is performed in the process of establishing the connection between the first node and the second node, first information is carried in the request message for establishing a PC5 unicast link,
wherein after sending a request message for establishing a PC5 unicast link to the second node, the method further comprises:
receiving, by the first node, second information sent by the second node when a first condition is met.

5. The node selection method according to claim 4, wherein the request message for establishing the PC5 unicast link comprises at least one of the following:
a Direct Communication Request message;
a newly defined request message for establishing a PC5 unicast link; or
a message related to establishment security of the second node.

6. The node selection method according to claim 3, wherein:
when the request message for establishing the PC5 unicast link is a Direct Communication Request message, the second information is carried in a Direct Communication Accept message;
when the request message for establishing the PC5 unicast link is a newly defined request message for establishing a PC5 unicast link, the second information is carried in a newly defined request message for responding to establishment of the PC5 unicast link; or
when the request message for establishing the PC5 unicast link is a message related to establishment security of the second node, the second information is carried in a message related to establishment security of the first node.

7. The node selection method according to claim 1, wherein when selecting, by the first node, the second node is performed after the process of establishing the connection between the first node and the second node, the method further comprises:
sending, by the first node, first information to the second node, wherein content of the first information comprises at least one of the following: a first requirement; positioning-related information; information about the first node; or requesting for information about the second node,
wherein after sending, by the first node, the first information to the second node, the method further comprises: receiving, by the first node, the second information sent by the second node when a first condition is met,
wherein:
the first condition comprises at least one of the following:
when the first information comprises a first requirement, the second node meets the first requirement in the first information; or
when the first information comprises positioning-related information, the second node is interested in the positioning-related information in the first information,
wherein content of the second information comprises at least one of the following:
Zone information of the second node;
a Reference Signal Receiving Power (RSRP) value measured by the second node;
movement state information of the second node, wherein the movement state information comprises at least one of the following: a static state or a moving state, a movement speed value, a level of a movement speed, a movement speed is not lower than a fifth threshold or not higher than a sixth threshold, or an interval of a movement speed value;
a network coverage state of the second node, wherein the network coverage state comprises at least one of the following: being located in a coverage range of a base station, or not being located in a coverage range of a base station;
a PC5 unicast link state of the second node, wherein the PC5 unicast link state comprises at least one of the following:
having established a PC5 unicast link to other terminals or having not established a PC5 unicast link to other terminals,
when being a PC5 unicast link state of the second node, having established a PC5 unicast link to other terminals other than the first node or having not established a PC5 unicast link to other terminals other than the first node,
a quantity of other terminals to which a PC5 unicast link has been established is not lower than a seventh threshold,
when being a PC5 unicast link state of the second node, a quantity of other terminals other than the first node to which a PC5 unicast link has been established is not lower than an eighth threshold,
a quantity of other terminals to which a PC5 unicast link has been established is not higher than a ninth threshold,
when being a PC5 unicast link state of the second node, a quantity of other terminals other than the first node to which a PC5 unicast link has been established is not higher than a tenth threshold,
a set of a quantity of other terminals to which a PC5 unicast link has been established; or
when being a PC5 unicast link state of the second node, a set of a quantity of other terminals other than the first node to which a PC5 unicast link has been established; or
positioning-related capability information of the second node, wherein the positioning-related capability information comprises at least one of the following: having an absolute positioning capability, having a relative positioning capability, having a Radio Access Technology-dependent (RAT-dependent) positioning capability, having an RAT-independent positioning capability, having a capability of performing positioning through a sidelink, positioning precision, or a capability having positioning integrity,
wherein:
the first requirement comprises at least one of the following:
a capability requirement on the second node, wherein the capability requirement on the second node comprises at least one of the following: having an absolute positioning capability, having a relative positioning capability, having an RAT-dependent positioning capability, having an RAT-independent positioning capability, having a capability of performing positioning through a sidelink, positioning precision, or a capability having positioning integrity;
an RSRP threshold value;
a requirement on Zone information of the second node;
a movement state requirement on the second node, wherein the movement state requirement on the second node comprises at least one of the following: being in a static state, being in a moving state, a static state is prior to a moving state, a movement speed is not higher than a first threshold, a movement speed is a value in a set, a movement speed is not lower than a second threshold, or a level of a movement speed;
a network coverage state requirement on the second node, wherein the network coverage state requirement on the second node comprises at least one of the following that: the second node needs to be located in a coverage range of a base station, or the second node does not need to be located in a coverage range of a base station; or
a PC5 unicast link state requirement on the second node, wherein the PC5 unicast link state requirement on the second node comprises at least one of the following: needing to have established a PC5 unicast link to other terminals other than the first node, not needing to have established a PC5 unicast link to other terminals other than the first node, a quantity of other terminals to which a PC5 unicast link has been established is not lower than a third threshold, a quantity of other terminals to which a PC5 unicast link has been established is not higher than a fourth threshold, or a set or interval of a quantity of other terminals to which a PC5 unicast link has been established,
the positioning-related information comprises at least one of the following:
positioning precision/accuracy;
positioning integrity;
a positioning type;
a positioning update cycle; or
a positioning technology, or
the information about the first node or the information about the second node comprises at least one of the following:
Zone information of the first node or the second node;
movement state information;
a network coverage state;
a PC5 unicast link state; or
positioning-related capability information.

8. The node selection method according to claim 7, wherein the first node sends the first information to the second node through at least one of the following:
a UECapabilityEnquirySidelink message;
an RRCReconfigurationSidelink message;
a Link Identifier Update Request message;
a Link Identifier Update Ack message;
a Disconnect Request message;
a Link Modification Request message;
a Keep-alive message;
a newly defined PC5-RRC message; or
a newly defined PC5-S message.

9. The node selection method according to claim 8, wherein:
when the first node sends the first information to the second node through the UECapabilityEnquirySidelink message, the second information is carried in a UECapabilityInformationSidelink message;
when the first node sends the first information to the second node through the RRCReconfigurationSidelink message, the second information is carried in an RRCReconfigurationCompleteSidelink message;
when the first node sends the first information to the second node through the Link Identifier Update Request message, the second information is carried in a Link Identifier Update Response message;
when the first node sends the first information to the second node through the Disconnect Request message, the second information is carried in a Disconnect Response message;
when the first node sends the first information to the second node through the Link Modification Request message, the second information is carried in a Link Modification Accept message;
when the first node sends the first information to the second node through the Keep-alive message, the second information is carried in a Keep-alive Ack message;
when the first node sends the first information to the second node through the newly defined PC5-RRC message, the second information is carried in the newly defined PC5-RRC message; or
when the first node sends the first information to the second node through the newly defined PC5-S message, the second information is carried in the newly defined PC5-S message.

10. The node selection method according to claim 1, wherein when selecting, by the first node, the second node is performed in the process of establishing the connection between the first node and the second node, or when the second node does not need to establish a connection to the first node, the method further comprises:
broadcasting, by the first node, first information to the second node,
wherein after broadcasting, by the first node, first information to the second node, the method further comprises:
receiving, by the first node, the second information sent by the second node when a first condition is met,
wherein:
the first condition comprises at least one of the following:
when the first information comprises a first requirement, the second node meets the first requirement in the first information; or
when the first information comprises positioning-related information, the second node is interested in the positioning-related information in the first information,
wherein content of the second information comprises at least one of the following:
Zone information of the second node;
a Reference Signal Receiving Power (RSRP) value measured by the second node;
movement state information of the second node, wherein the movement state information comprises at least one of the following: a static state or a moving state, a movement speed value, a level of a movement speed, a movement speed is not lower than a fifth threshold or not higher than a sixth threshold, or an interval of a movement speed value;
a network coverage state of the second node, wherein the network coverage state comprises at least one of the following: being located in a coverage range of a base station, or not being located in a coverage range of a base station;
a PC5 unicast link state of the second node, wherein the PC5 unicast link state comprises at least one of the following:
having established a PC5 unicast link to other terminals or having not established a PC5 unicast link to other terminals,
when being a PC5 unicast link state of the second node, having established a PC5 unicast link to other terminals other than the first node or having not established a PC5 unicast link to other terminals other than the first node,
a quantity of other terminals to which a PC5 unicast link has been established is not lower than a seventh threshold,
when being a PC5 unicast link state of the second node, a quantity of other terminals other than the first node to which a PC5 unicast link has been established is not lower than an eighth threshold,
a quantity of other terminals to which a PC5 unicast link has been established is not higher than a ninth threshold,
when being a PC5 unicast link state of the second node, a quantity of other terminals other than the first node to which a PC5 unicast link has been established is not higher than a tenth threshold,
a set of a quantity of other terminals to which a PC5 unicast link has been established; or
when being a PC5 unicast link state of the second node, a set of a quantity of other terminals other than the first node to which a PC5 unicast link has been established; or
positioning-related capability information of the second node, wherein the positioning-related capability information comprises at least one of the following: having an absolute positioning capability, having a relative positioning capability, having a Radio Access Technology-dependent (RAT-dependent) positioning capability, having an RAT-independent positioning capability, having a capability of performing positioning through a sidelink, positioning precision, or a capability having positioning integrity,
wherein:
the first requirement comprises at least one of the following:
a capability requirement on the second node, wherein the capability requirement on the second node comprises at least one of the following: having an absolute positioning capability, having a relative positioning capability, having an RAT-dependent positioning capability, having an RAT-independent positioning capability, having a capability of performing positioning through a sidelink, positioning precision, or a capability having positioning integrity;
an RSRP threshold value;
a requirement on Zone information of the second node;
a movement state requirement on the second node, wherein the movement state requirement on the second node comprises at least one of the following: being in a static state, being in a moving state, a static state is prior to a moving state, a movement speed is not higher than a first threshold, a movement speed is a value in a set, a movement speed is not lower than a second threshold, or a level of a movement speed;
a network coverage state requirement on the second node, wherein the network coverage state requirement on the second node comprises at least one of the following that: the second node needs to be located in a coverage range of a base station, or the second node does not need to be located in a coverage range of a base station; or
a PC5 unicast link state requirement on the second node, wherein the PC5 unicast link state requirement on the second node comprises at least one of the following: needing to have established a PC5 unicast link to other terminals other than the first node, not needing to have established a PC5 unicast link to other terminals other than the first node, a quantity of other terminals to which a PC5 unicast link has been established is not lower than a third threshold, a quantity of other terminals to which a PC5 unicast link has been established is not higher than a fourth threshold, or a set or interval of a quantity of other terminals to which a PC5 unicast link has been established,
the positioning-related information comprises at least one of the following:
positioning precision/accuracy;
positioning integrity;
a positioning type;
a positioning update cycle; or
a positioning technology, or
the information about the first node or the information about the second node comprises at least one of the following:
Zone information of the first node or the second node;
movement state information;
a network coverage state;
a PC5 unicast link state; or
positioning-related capability information.

11. The node selection method according to claim 10, wherein:
when selecting, by the first node, the second node is performed in the process of establishing the connection between the first node and the second node, the second information is carried in a Direct Communication Request message;
when selecting, by the first node, the second node is performed in the process of establishing the connection between the first node and the second node, the second information is carried in a newly defined request message for establishing a PC5 unicast link;
when selecting, by the first node, the second node is performed in the process of establishing the connection between the first node and the second node, the second information is carried in a message related to establishment security of the first node; or
when the second node does not need to establish the connection to the first node, the second information is carried in a broadcast message other than a request message for establishing a PC5 unicast link.

12. The node selection method according to any one of claim 1, wherein selecting, by the first node, the second node comprises:
selecting, by the first node, the second node according to a first rule, wherein
the first rule is agreed on in a protocol or depends on an implementation of the first node,
wherein after selecting, by the first node, the second node, the method further comprises: at least one of the following:
sending, by the first node, the third information to a selected second node; or
sending, by the first node, the third information to an unselected second node.

13. The node selection method according to claim 12, wherein the third information comprises at least one of the following:
when the first node sends the third information to a selected second node, information used for indicating that the second node is selected by the first node as a node used for performing positioning;
when the first node sends the third information to an unselected second node, information used for indicating that the second node is not selected by the first node as a node used for performing positioning;
information used for indicating that the second node is not selected by the first node as a node used for performing positioning; or
information used for indicating that the second node is selected by the first node as a node used for performing positioning.

14. The node selection method according to claim 1, wherein selecting, by the first node, the second node comprises:
selecting, by the first node, the second node according to first indication information sent by a third node,
wherein the third node is one of the following:
a base station; or
a core network function.

15. A terminal, comprising a processor; a memory having a computer program or an instruction stored thereon, wherein the computer program or the instruction, when executed by the processor, causes the processor to perform operations comprising:
selecting, by a first node, a second node, wherein the second node is used for performing positioning together with the first node,
wherein:
the first node is at least one of the following:
a terminal;
a base station, or
a core network function;
the second node is at least one of the following:
a terminal;
a base station, or
a core network function; and
the second node comprises at least one of the following:
a node that does not need to establish a connection to the first node; or
a node that needs to establish a connection to the first node,
wherein when the second node is a node that needs to establish a connection to the first node, selecting, by a first node, a second node is performed either in a process of establishing a connection between the first node and the second node, or after the process of establishing a connection between the first node and the second node.

16. The terminal according to claim 15, wherein establishing the connection between the first node and the second node comprises one of the following:
when one of the first node and the second node is a terminal and the other is a base station, establishing a Radio Resource Control (RRC) connection between the first node and the second node;
when both the first node and the second node are terminals, establishing a PC5 unicast link connection between the first node and the second node; or when both the first node and the second node are terminals, establishing a PC5-RRC connection between the first node and the second node; or
when one of the first node and the second node is a terminal and the other is a core network function, establishing a Non-Access Stratum (NAS) connection between the first node and the second node.

17. The terminal according to claim 16, wherein establishing the PC5 unicast link connection between the first node and the second node comprises at least one of the following:
sending, by the first node, a request message for establishing a PC5 unicast link to the second node in a PC5 broadcast manner; or
sending, by the first node, a request message for establishing a PC5 unicast link to the second node in a PC5 unicast manner.

18. The terminal according to claim 17, wherein when selecting, by the first node, the second node is performed in the process of establishing the connection between the first node and the second node, first information is carried in the request message for establishing a PC5 unicast link,
wherein after sending the request message for establishing the PC5 unicast link to the second node, the operations further comprise:
receiving, by the first node, second information sent by the second node when a first condition is met.

19. The terminal according to claim 18, wherein the request message for establishing the PC5 unicast link comprises at least one of the following:
a Direct Communication Request message;
a newly defined request message for establishing a PC5 unicast link; or
a message related to establishment security of the second node.

20. The terminal according to claim 17, wherein:
when the request message for establishing the PC5 unicast link is a Direct Communication Request message, the second information is carried in a Direct Communication Accept message;
when the request message for establishing the PC5 unicast link is a newly defined request message for establishing a PC5 unicast link, the second information is carried in a newly defined request message for responding to establishment of the PC5 unicast link; or
when the request message for establishing the PC5 unicast link is a message related to establishment security of the second node, the second information is carried in a message related to establishment security of the first node.
